(19) United States
(12) Patent Application Publication
(10) Pub. No.: US 2024/0097529 A1
(43) Pub. Date: Mar. 21, 2024

(54) STATOR LAMINATED CORE FOR ACCOMMODATING AT LEAST ONE COIL UNIT, STATOR SEGMENT, STATOR, ROTOR SEGMENT, ROTOR, GENERATOR, WIND TURBINE AND METHOD FOR PRODUCING A ROTOR SEGMENT

(71) Applicant: Wobben Properties GmbH, Aurich (DE)

(72) Inventors: Manuel Feith, Esens (DE); Wojciech Giengiel, Aurich (DE); Stephan Jöckel, Kleinniedesheim (DE); Andreas Recktenwald, Saarbrücken (DE); Tobias Muik, Bensheim (DE); Charan Karapanahalli, Mannheim (DE)

(21) Appl. No.: 18/257,852

(22) PCT Filed: Dec. 17, 2021
(86) PCT No.: PCT/EP2021/086459

§ 371 Date: Jun. 15, 2023

(30) Foreign Application Priority Data
Dec. 18, 2020 (EP) 20215477.9

(51) Int. Cl. H02K 7/18; H02K 1/14; H02K 1/18; H02K 1/2789; H02K 15/03; H02K 15/12

(52) U.S. Cl. CPC H02K 7/1838; H02K 1/148; H02K 1/18; H02K 1/2789; H02K 15/03; H02K 15/12; H02K 2213/03

(57) ABSTRACT

A stator laminated core for receiving at least one coil unit of a stator segment of a stator of a generator, in particular a segmented stator of a segmented generator, for a wind turbine, comprises at least one stator lamination stack with two or more lamination stack units which are disposed spaced apart from one another in a circumferential direction and have a plurality of first stator lamination elements which are disposed next to one another, in particular stacked, in an axial direction; wherein the at least one stator lamination stack comprises at least one second stator lamination element, preferably two second stator lamination elements, which is different from the first stator lamination element and in each case connects adjacent lamination stack units of the two or more lamination stack units to one another.

### BACKGROUND

### Technical Field

The disclosure relates to a generator of a wind turbine. Furthermore, the disclosure relates to a stator laminated core for receiving at least one coil unit of a stator segment of a stator of a generator for a wind turbine. Furthermore, the disclosure relates to a stator segment of a stator of a generator for a wind turbine and a stator of a generator for a wind turbine. Furthermore, the disclosure relates to a rotor segment of a rotor of a generator for a wind turbine. Furthermore, the disclosure relates to a rotor of a generator of a wind turbine. Furthermore, the disclosure relates to a wind turbine.

### Description of the Related Art

A wind turbine is a system that converts kinetic energy from wind into electric energy and feeds it into a power grid. For the conversion of the kinetic energy into electric energy, the wind turbine comprises a generator with a rotor, which is mounted so as to be rotatable about an axis of rotation relative to a stator. Depending on the position of the axis of rotation, a distinction is made between a horizontal and a vertical wind turbine. In the case of the horizontal wind turbine, the axis of rotation is aligned horizontally. In the case of the vertical wind turbine, the axis of rotation is aligned vertically. Horizontal wind turbines are also known as horizontal-axis wind turbines and vertical wind turbines are also known as vertical-axis wind turbines.

Modern wind turbines generally concern so-called horizontal-axis wind turbines, in the case of which the axis of rotation is disposed substantially horizontally and the rotor blades sweep through a substantially vertical rotor area. Furthermore, wind turbines have a nacelle which is disposed on a tower of the wind turbine so that it can rotate about a substantially vertical axis.

When the wind turbine is in an operating state, the wind causes a rotating movement of the rotor blades which drive the rotor of a generator which is coupled to the rotor blades. In the operating state, the rotor blades and the rotor rotate relative to a stator of the generator. Due to the relative movement between rotor and stator, the (electric) generator generates electric energy. In the operating state of the wind turbine, the wind turbine is constructed at the installation site and is operated to convert the kinetic energy of the wind into electric energy.

Wind turbines can be embodied without a gear or with a gear. In particular, gearless wind turbines have generators with a large diameter. It is quite common for the generators to have a diameter of 5 m and more. Such generators can reach a mass of 150 t and more. These generators can be embodied as so-called internal rotors or as so-called external rotors. In the case of an internal rotor, the rotor of the generator rotating with the rotor blades is disposed inside a fixed stator of the generator. In the case of an external rotor, the rotor is disposed outside the stator. In the case of the external rotor, the stator is in particular disposed inside the rotor, preferably radially inside in terms of the rotor. Irrespective of the type of the generator, generators are usually fastened to the nacelle, in particular a machine carrier, of the wind turbine.

Large (permanent) magnetic and dynamic forces are at work in permanently excited generators, particularly in the sizes outlined. In particular, these forces act to excite vibrations by virtue of the rotating structure of the generator. A generator excited to vibrate in this way can emit noise and in this respect pollute the environment.

The European Patent Office has searched the following prior art in the priority application for the present application: DE 198 42 948 A1, EP 2 854 256 A1, WO 2014/000757 A1, EP 3 657 633 A1, US 2015/229166 A1, WO 2004/114500, CN 103 312 058 A, JP 2002 010539 A, US 2017/033626 A1, DE 10 2010 041 593 A1, US 2011/043065 A1, EP 2 523 316 A1.

### BRIEF SUMMARY

Some embodiments provide a generator for a wind turbine, a stator laminated core of a stator segment of a stator for a generator of a wind turbine, a stator segment of a stator for a generator of a wind turbine, a stator for a generator of a wind turbine, a rotor segment of a rotor for a generator of a wind turbine, a rotor for a generator of a wind turbine, a wind turbine, and a method for producing a rotor segment of a generator, that eliminate or reduce one or a plurality of the disadvantages mentioned. In particular, some embodiments provide a solution that enables noise-optimized operation of a wind turbine.

Some embodiments provide a generator, in particular by a segmented generator, for a wind turbine.

Unless expressly stated otherwise, information pertaining to an axial direction, a circumferential direction and a radial direction in the description is to be understood in terms of an axis of rotation of the generator. The axial direction corresponds to a direction parallel, i.e., along, the axis of rotation. The circumferential direction corresponds to a direction substantially tangential to the axis of rotation. The radial direction corresponds to a direction radial to the axis of rotation.

The segmented generator for a wind turbine comprises two or more generator segments. The two or more generator segments are preferably disposed in an annular manner. In particular, the two or more generator segments are disposed coaxially with an axis of rotation of the segmented generator. In particular, the segmented generator comprises a segmented rotor and a segmented stator. The segmented rotor comprises two or more rotor segments. The segmented stator comprises two or more stator segments.

The respective generator segment or the respective rotor segment and/or the respective stator segment in terms of the axis of rotation are preferably configured in a part-annular manner in a circumferential direction. In particular, the generator segment or the rotor segment and/or the stator segment have a part-annular geometry. A generator segment or a rotor segment and/or a stator segment, which is correspondingly configured in a part-annular manner or has a part-annular geometry, extends in the circumferential direction by way of a specific degree of arc between a first and second separation interface.

The two or more generator segments or the two or more rotor segments and/or two or more stator segments preferably extend with the same degree of arc in the circumferential direction. In particular, the generator segments or the rotor and/or stator segments extend as a function of the following formula, depending on the number of the respective segments: 360°/(number of segments). According to this, for example, the generator segments of a segmented generator, which comprises two generator segments, each extend in the circumferential direction by 180°, in the case of three generator segments it would be 120°, in the case of four generator segments it would be 90°, etc. This can apply in an analogous manner to the rotor segments and/or stator segments.

It may also be preferable that the generator segments, from which a segmented generator is assembled, extend in the circumferential direction with a different degree of arc. For example, a segmented generator can be formed from three generator segments. In such a segmented generator, for example, a first generator segment can extend in the circumferential direction by 180°, a second generator segment by 120° and a third generator segment by 60°. Any other extents in the circumferential direction of the generator segments are conceivable, provided that when assembled they result in an extent of 360° in the circumferential direction. The explanations regarding the generator segment can apply in an analogous manner to a rotor segment of a segmented rotor and/or a stator segment of a segmented stator.

The first and second separation interface extend substantially orthogonally to the circumferential direction. In particular, the first and second separation interface define a first and second separation interface plane within which the axis of rotation extends. In particular, the first and/or second separation interface extend in such a manner that the first and/or second separation interface plane extend in a radial direction in relation to the axis of rotation. In particular, the first and/or second separation interface plane, which extend in the radial direction in relation to the axis of rotation, intersect in an axis that is or defines the axis of rotation. In particular, the axis of rotation lies in the first and/or second separation interface plane, which extend in the radial direction in relation to the axis of rotation.

The first and/or second separation interface of a generator segment has a connection device. The connection device at the first and/or second separation interface is configured to connect adjacent generator segments that are disposed to form a segmented generator to one another. The connecting device of the first and/or second separation interface is configured in particular to mechanically connect adjacent generator segments. The mechanical connection can be configured as a force-fitting and/or materially integral and/or form-fitting connection. The first and/or second separation interface preferably have a flange connection and/or a threaded connection as a connecting device for fastening adjacent generator segments in the circumferential direction. The explanations regarding the generator segment can apply in an analogous manner to a rotor segment of a segmented rotor and/or a stator segment of a segmented stator.

In particular, it can be preferred that the rotor segment, in particular its magnet carrier segment, extends in the circumferential direction between the first and second separation interface with a segment length, wherein the rotor segment or the magnet carrier segment has an external circumferential face with a first separation interface portion with a first length proceeding from the first separation interface in the circumferential direction toward the second separation interface; and a second separation interface portion with a second length proceeding from the second separation interface in the circumferential direction toward the first separation interface; and a connecting portion with a third length extending between the first and second separation interface; wherein in each case a reinforcement device for reinforcing the magnet carrier segment is disposed in the region of the first and second separation interface portion on the rotor circumferential face. In addition or as an alternative, it can be preferred that the rotor segment has a reinforcement ring segment and/or a reinforcement disk.

In addition or as an alternative, it is also preferred that the segmented generator is configured as a permanently excited segmented generator. In this preferred embodiment, it is provided that one or a plurality of permanent magnets are disposed on the rotor. A permanent magnet, also known as a permanently excited magnet, is a magnet that has a constant magnetic field that is not generated by electric power, as is the case with electromagnets. The permanent magnet comprises or is composed of a magnetized material. Examples of magnetized materials of a permanent magnet are alloys of iron, cobalt, nickel, etc.

The segmented generator is preferably configured as an external rotor. In the case of a segmented generator configured as an external rotor, the stator or segmented stator, in terms of the axis of rotation, in the radial direction is located on the inside in relation to the rotor or segmented rotor. In the case of a segmented generator configured as an external rotor, its segmented rotor, which lies radially on the outside, usually encloses the segmented stator that lies radially on the inside.

With the segmented design of the generator, transport-related size restrictions of a generator can be overcome. In particular, as a result of the individual transport of the generator segments, segmented generators can also be transported to installation sites of wind turbines that are difficult to access and assembled on the tower of the wind turbines on the nacelle. In particular, no large and expensive special cranes are required for the assembly of a segmented generator. Rather, the generator segments can be positioned individually on the nacelle or the machine carrier with a small crane, which only has to carry the mass of a single generator segment and reach the assembly height. This saves costs that would otherwise be incurred for the substantially more expensive large cranes. Furthermore, such large cranes are generally only available to a limited extent, and so the segmented generator offers more flexibility with regard to the assembly time and also the assembly site.

In the operating state of the wind turbine, the segmented generator is fastened in particular to a bearing unit. The bearing unit has a stationary bearing part and a rotating or rotatable bearing part. The rotatable bearing part, by means of bearing elements, for example ball bearings, roller bearings, barrel bearings or the like, is rotatably mounted relative to the stationary bearing part about the axis of rotation. In the operating state, the segmented stator is fastened to the stationary bearing part. In the operating state, the segmented rotor is fastened to the rotatable bearing part. In order to fasten the stator, the bearing unit preferably has a stator main body flange on the stationary bearing part. In order to fasten the rotor, the bearing unit preferably has a rotor main body flange on the rotatable bearing part. It is to be understood that the flange surface of the stator main body flange and of the rotor main body flange are disposed at a spacing from one another, in particular by way of the mutual axial spacing.

With respect to further advantages, design variants and design details of the segmented generator according to the disclosure and its refinements, reference is also made to the following description of the corresponding features and refinements of the stator laminated core, the stator segment, the stator, the rotor segment, the rotor, the wind turbine and the method for producing a rotor.

Some embodiments provide a stator laminated core for receiving at least one coil unit of a stator segment of a stator of a generator for a wind turbine. Some embodiments provide a stator laminated core for receiving at least one coil unit of a stator segment of a segmented stator of a segmented generator for a wind turbine.

The stator laminated core in the circumferential direction extends substantially tangentially to the axis of rotation with a stator laminated core length. The stator laminated core in the circumferential direction, by way of the stator laminated core length, preferably extends between a first and second end portion. The stator laminated core in the circumferential direction preferably extends in an annular or part-annular manner. The stator laminated core in the axial direction, by way of a stator laminated core width, furthermore extends parallel to the axis of rotation. The stator laminated core in the axial direction, by way of the stator laminated core width, extends in particular between a first and second stator pressure sheet. The stator laminated core in the radial direction extends by way of a stator laminated core height. The stator laminated core by way of the stator laminated core height extends between a radially inner stator laminated core internal face and a radially outer stator laminated core external face. It is preferred that the stator laminated core length is greater than the stator laminated core width. Furthermore, it is preferred that the stator laminated core width is greater than the stator laminated core height.

The stator laminated core comprises at least one stator lamination stack with two or more lamination stack units. The at least one stator laminated core has, in particular, at least two stator lamination stacks, wherein adjacent stator lamination stacks of the at least two stator lamination stacks are each disposed so as to be spaced apart parallel to one another in an axial direction and each form a stator cooling duct with a stator cooling duct width through which a cooling medium can be passed through, in particular in a radial direction.

The at least two stator lamination stacks preferably have the same stator lamination stack width in the axial direction. The stator lamination stack width is preferably greater than the stator cooling duct width. In particular, the stator lamination stack width corresponds to at least 110%, 120%, 150%, 200% or 500% of the stator cooling duct width. It can also be preferred that the stator lamination stack width corresponds to the stator cooling duct width. Furthermore, it can alternatively be preferred that the stator lamination stack width is smaller than the stator cooling duct width. In particular, the stator lamination stack width corresponds to at least 50%, 60%, 70%, 80% or 90% of the stator cooling duct width. In particular, at least one spacer element is disposed between adjacent stator lamination stacks, which spacer element defines the stator cooling duct width. The at least one spacer element preferably has an extent in the circumferential direction and/or the radial direction that is smaller than an extent of the first and/or second lamination element in the circumferential direction and/or radial direction. The height of the stator cooling duct corresponds in particular to a first height of a first portion of the stator laminated core. The length of the stator cooling duct preferably corresponds to the length of the stator laminated core in the circumferential direction. The stator laminated core preferably comprises at least 4, 8, 12, 16, 20, 24, 28, 32 or more stator cooling ducts.

The two or more lamination stack units are disposed so as to be spaced apart from each other in a circumferential direction. The two or more lamination stack units include a plurality of first stator lamination elements. The plurality of first stator lamination elements are disposed next to one another, in particular stacked, in an axial direction. Furthermore, the at least one stator lamination stack comprises at least one second stator lamination element, preferably two second stator lamination elements. The at least one second stator lamination element is different from the first stator lamination element. The at least one second stator lamination element in each case connects adjacent lamination stack units of the two or more lamination stack units to one another.

In particular, the first and second stator lamination element in the circumferential direction have one or a plurality of first portions which extend in the radial direction by way of a first height, and one or a plurality of second portions which extend in the radial direction by way of a second height. The first height is preferably different from the second height. In particular, the second height is smaller than the first height. In particular, the first portion extends in the circumferential direction by way of a first length and the second portion by way of a second length. The first length is preferably different from the second length. In particular, the second length is smaller than the first length. First and second portions disposed alternately in the circumferential direction preferably form a first and/or second stator lamination element. In particular, a first portion extends in the circumferential direction between two second portions. In particular, the first portion forms a protrusion or stud opposite the second portion in the radial direction, said protrusion or stud extending radially outward proceeding from the stator internal circumferential face.

Furthermore, it is preferred that the first and/or second stator lamination element extend between an end face lying on the inside in the radial direction and an end face lying on the outside in the radial direction. It is to be understood that the outer end face in terms of the inner end face is disposed outward in the radial direction. The first and/or second stator lamination element preferably have a plurality of recesses on the inner end face. The recesses extend in particular so as to proceed from the inner end face in the direction of the outer end face. The recesses are configured for fastening the first and/or second stator lamination element to a fastening device described in more detail below. The recesses are preferably disposed at a spacing from one another in the circumferential direction. In particular, the recesses are disposed equidistantly from one another in the circumferential direction.

The recesses can have different cross sections. In particular, it is preferred that the recesses have a trapezoidal and/or parallelogram-shaped cross section. In particular, it is provided that the recesses with a trapezoidal cross section open in the direction of the inner end face. Furthermore, it is to be understood that a parallelogram-shaped cross section may be formed as a left-oriented parallelogram-shaped cross section or may be formed as a right-oriented parallelogram-shaped cross section. In the case of a left-oriented parallelogram-shaped cross section, the side walls of the recesses are inclined to the left, starting from the inner end face, in a plan view of the first and/or second stator lamination element. Correspondingly, in the case of a right-oriented parallelogram-shaped cross section, the side walls are inclined to the right in the same plan view.

It can be preferred that recesses disposed adjacently in the circumferential direction have the same cross sections. In particular, recesses may have only trapezoidal cross sections or have only parallelogram-shaped cross sections.

Furthermore, it can be preferred that recesses disposed adjacently in the circumferential direction have different cross sections. In particular, it is preferred that a recess with a trapezoidal cross section is always disposed between two recesses with a parallelogram-shaped cross section. In particular, it is provided that a recess with a parallelogram-shaped cross section and a recess with a trapezoidal cross section are disposed alternately in the circumferential direction. Preferably, a recess having a trapezoidal cross section is disposed between a recess having a right-oriented parallelogram-shaped cross section and a recess having a left-oriented parallelogram-shaped cross section. Furthermore, it can be preferred that the first and/or second stator lamination element has two recesses with a left-oriented parallelogram-shaped cross section, which are followed in the circumferential direction by two recesses with a right-oriented parallelogram-shaped cross section. In particular, it can be provided that the first and/or second stator lamination element has the recesses in this order, alternating in the circumferential direction.

The statements relating to the first and/or second stator lamination element, in particular to the recesses, apply correspondingly to the first and second stator pressure sheet, between which the first and/or second stator lamination elements are disposed in the axial direction.

This configuration of the first and/or second stator lamination element and/or of the first and/or second stator pressure sheet allows the stator laminated core to be mounted particularly quickly, easily and inexpensively in a particularly simple manner on the fastening device described in detail below. In particular, the first and/or second stator lamination element and/or the first and second stator pressure sheet can be connected to one another with the fastening device by being plugged and/or pushed on. Stator lamination elements configured in this way allow a particularly advantageous form-fit of the stator lamination elements and to this extent also of the stator laminated core to be produced by the fastening device.

It is to be understood that the first and/or second stator lamination elements are disposed on one another in the axial direction in such a manner that they form a section of a fastening groove, by means of which the stator laminated core is fastened to the fastening device. In particular, it is provided that the recesses of the first and/or second stator lamination elements disposed adjacently in the axial direction, which form the section of a fastening groove, have different cross sections. In particular, it can be preferred that the section of the fastening groove is formed in the axial direction by recesses which, in particular alternately, have a trapezoidal cross section and/or a parallelogram-shaped cross section. In particular, it is provided that the first and/or second stator lamination elements disposed adjacently in the axial direction are disposed offset to one another in the circumferential direction. In particular, it is preferred that the first and/or second stator lamination elements disposed adjacently in the axial direction are disposed offset to one another in the circumferential direction by at least one, two or more recesses. With this arrangement, the noise emission due to vibrations can be minimized in a particularly advantageous manner.

It is to be understood that the first and second stator lamination element are disposed such that the two or more lamination stack units of the at least one stator lamination stack have one or a plurality of first portions which extend in the radial direction by way of the first height and in the circumferential direction by way of the first length, and have one or a plurality of second portions which extend in the radial direction by way of the second height and in the circumferential direction by way of the second length. In this respect it is also to be understood that the at least one stator lamination stack and the stator laminated core according to the two or more lamination stack units have at least one first and/or at least one second portion.

The at least one stator laminated core is configured to receive at least one coil unit. In particular, a coil unit is disposed on the stator laminated core in such a manner that a first portion of the stator laminated core extends in the radial direction within the coil unit. The coil unit is preferably disposed on the stator laminated core in such a manner that the first portion of the stator laminated core extends through the coil unit in the radial direction. In particular, the coil unit is disposed on the stator laminated core in such a manner that the former bears on one, in particular on two, second portion(s) of the stator laminated core in the radial direction.

The configuration of the stator lamination stacks with lamination stack units disposed at a spacing from one another in the circumferential direction has the advantage that harmonic vibrations, and to this extent the noise emission of the generator, in particular of the segmented generator, that has the described stator laminated core, is reduced. In particular, the aspect is based on the finding of the inventors that the lamination stack units disposed adjacent to one another in the circumferential direction are spaced apart from one another by such a spacing, which corresponds to the spacing between stator laminated cores disposed spaced apart from one another in the circumferential direction. In a particularly advantageous manner, this leads to a uniform magnetic field and in this respect to a uniform (vibro-acoustic) excitation of the generator, in particular of the segmented generator, and minimizes interference noise.

Furthermore, this construction mode has the advantage that a stator laminated core and, in this respect, also a stator segment, stator or generator, which can be operated in a particularly noise-optimized, in particular noise-minimized, manner, can be produced in a particularly simple and cost-effective manner.

The stator laminated core according to the disclosure and its refinements have features that make them particularly suitable for use for a stator segment according to the disclosure and/or a stator according to the disclosure and/or a generator according to the disclosure and/or a wind turbine according to the disclosure and the respective refinements. In terms of further advantages, design variants and design details of the stator laminated core according to the disclosure and its refinements, reference is also made to the previously given description of the corresponding features and refinements of the generator and the following description of the corresponding features and refinements of the stator segment, the stator, the rotor segment, the rotor, the wind turbine and the method for producing a rotor segment.

In a preferred embodiment of the stator laminated core, it is provided that the first stator lamination elements of the plurality of first stator lamination elements have a first lamination length in the circumferential direction and the at least one second stator lamination element has a second lamination length in the circumferential direction, wherein the second lamination length extends at least twice as far in the circumferential direction in comparison to the first lamination length. In particular, it is preferred that the second lamination length corresponds to twice the first lamination length plus the spacing between lamination stack units disposed adjacently in the circumferential direction.

This has the advantage that a stator laminated core, and in this respect also a stator segment, stator or generator, which can be operated in a particularly noise-optimized, in particular noise-minimized, manner, can be produced in a particularly simple and cost-effective manner.

Additionally or alternatively, it is preferred that the first stator lamination elements have a first lamination width in the axial direction and the at least one second stator lamination element has a second lamination width in the axial direction, which corresponds to the first lamination width. It can also be preferred that the first lamination width is different from the second lamination width. In particular, the first lamination width can be larger or smaller than the second lamination width.

A stator laminated core having first and second lamination elements, wherein the first and second lamination width are identical, has the advantage that a stator laminated core and in this respect also a stator segment, stator or generator, which can be operated in a particularly noise-optimized, in particular noise-minimized, manner, can be produced in a particularly simple and cost-effective manner. A stator laminated core having first and second lamination elements, wherein the first and second lamination width are different, has the advantage that the stator laminated core can be adapted in particular to the individual requirements of the generator to be produced.

According to a further preferred refinement of the stator laminated core, it is provided that the two or more lamination stack units are disposed so as to be spaced apart from one another in the circumferential direction by a lamination stack spacing. The lamination stack spacing is more than 0 mm, in particular at least 0.5 mm, 1 mm, 1.5 mm, 2 mm, 3 mm, 4 mm or 5 mm, and/or at most 10 mm, 7.5 mm, 5 mm, 3 mm, 2 mm or 1 mm.

Furthermore, it is preferred that the stator lamination stack extends in the circumferential direction with an arc angle of at least 10° and of at most 20°, preferably of 15°±1°; and/or the plurality of first stator lamination elements extend in the circumferential direction with an arc angle of at least 2.5° and of at most 7.5°, preferably of 5°±1°; and/or the at least one second stator lamination element extends in the circumferential direction with an arc angle of at least 7.5° and of at most 12.5°, preferably of 10°±1°.

In addition or as an alternative, it is preferably provided that the stator laminated core comprises at least two stator lamination stacks, wherein adjacent stator lamination stacks of the at least two stator lamination stacks are disposed at a spacing from one another in the axial direction.

The configuration of the stator lamination stacks with lamination stack units disposed at a spacing from one another has the advantage that harmonic vibrations, and to this extent the noise emission of the generator, in particular of the segmented generator, which has the described stator laminated core, is reduced. In particular, the aspect is based on the finding of the inventors that the lamination stack units disposed adjacent to one another in the circumferential direction are spaced apart from one another by such a spacing, which corresponds to the spacing between stator laminated cores disposed spaced apart from one another in the circumferential direction. In a particularly advantageous manner, this leads to a uniform excitation of the generator, in particular of the segmented generator, and minimizes interference noise.

Such a stator laminated core has the advantage that a stator laminated core and, in this respect, also a stator segment, stator or generator, which can be operated in a particularly noise-optimized, in particular noise-minimized, manner, can be produced in a particularly simple and cost-effective manner.

Some embodiments provide a stator segment of a stator of a generator for a wind turbine. Some embodiments provide a stator segment of a segmented stator of a segmented generator for a wind turbine. It is to be understood that the stator segment is a stator segment for a stator, in particular for a segmented stator. Furthermore, it is to be understood that the stator is a stator for a generator, in particular for a segmented generator.

The stator segment comprises a coil carrier segment having an annular or part-annular geometry and a stator circumferential structure. Furthermore, the stator segment comprises at least one stator laminated core, which is configured to receive at least one coil unit and is disposed on the stator circumferential structure. In particular, the at least one stator laminated core has individual or all features of the stator laminated core described above and implements the advantages and effects of the latter.

In particular, the stator segment has a first and second carrier plate. The first and second carrier plate are disposed so as to be spaced apart from each other in the axial direction. Preferably, the stator circumferential structure connects the first and second carrier plate to one another. The stator circumferential structure is, for example, an assembly of one or a plurality of axial struts, which have a direction of main extent substantially along the axis of rotation in the axial direction. A plurality of axial struts are disposed so as to be spaced apart from one another, preferably equidistantly, in particular in the circumferential direction. It is to be understood that the coil carrier segment preferably forms the first and second carrier plate and/or the stator circumferential structure integrally, in particular in one piece. Preferably, at least one stator laminated core for receiving at least one coil unit is disposed on the stator circumferential structure.

The stator segment preferably extends in the radial direction between a radially inner flange for fastening the stator segment to a stator main body flange of the bearing unit and a radially outer coil carrier segment. In particular, the stator segment is configured as a shell structure. The stator segment preferably extends in the shape of a truncated pyramid from the flange to the coil carrier segment lying radially on the outside, the cross section of the stator segment increasing from the flange to the coil carrier segment lying radially on the outside. In particular, the stator segment forms, preferably integrally, a stator support portion which extends proceeding from the radially inner flange to the radially outer coil carrier segment.

The stator segment also comprises a fastening device for fastening the at least one stator laminated core to the coil carrier segment. The fastening device is configured as a clamping device for the force-fitting and/or form-fitting connection of the at least one stator laminated core to the coil carrier segment. The fastening device is preferably configured for the force-fitting and/or form-fitting connection of the at least one stator laminated core to the coil carrier segment in the radial direction and/or the circumferential direction and/or the axial direction. In particular, the fastening device is disposed on and/or fastened to the stator circumferential structure, preferably the axial struts of the stator circumferential structure.

The fastening device according to this aspect has the advantage that it can be produced in a particularly simple and cost-effective manner and enables the generator to be operated with minimized vibration, that is to say in a noise-optimized manner. In particular, this fastening device has the advantage that it enables a particularly easy and quick exchange of a stator laminated core. To this extent, such a generator can be operated in a particularly advantageous manner at low cost and with little noise.

The stator segment according to the disclosure and its refinements have features that make them particularly suitable for being used for a stator according to the disclosure and/or a generator according to the disclosure and/or a wind turbine according to the disclosure and the respective refinements. In terms of further advantages, design variants and design details of the stator segment according to the disclosure and its further refinements, reference is also made to the previously given description of the corresponding features and further refinements of the generator and of the stator laminated core and the following description of the corresponding features and further refinements of the stator, the rotor segment, the rotor, the wind turbine and the method for producing a rotor segment.

According to a preferred embodiment of the stator segment, it is provided that stator laminated cores disposed adjacently in the circumferential direction are disposed on the stator circumferential structure so as to be spaced apart from one another by a laminated core spacing; wherein the laminated core spacing preferably corresponds to the lamination stack spacing; or the laminated core spacing is greater than the lamination stack spacing; or the laminated core spacing is smaller than the lamination stack spacing.

The configuration of the stator segment according to this preferred refinement has the advantage that harmonic vibrations and, to that extent, the noise emission of the generator, in particular of the segmented generator that has the stator segment described, is reduced. In particular, the aspect is based on the finding of the inventors that the stator segments disposed adjacent to one another in the circumferential direction are spaced apart from one another by such a spacing, which corresponds to the spacing between stator lamination stack units disposed spaced apart from one another in the circumferential direction. In a particularly advantageous manner, this leads to a uniform excitation of the generator, in particular of the segmented generator, and minimizes interference noise.

Furthermore, it is preferred that the fastening device comprises at least one first clamping strip and/or at least one second clamping strip. The first and/or second clamping strip is, in particular, configured in a trapezoidal manner. The first and/or second clamping strip are configured for the force-fitting and/or form-fitting fastening of the fastening device to the at least one stator laminated core. Preferably, the first clamping strip is different from the second clamping strip.

Alternatively or additionally, the at least one first and/or second clamping strip has at least one contact face. The at least one contact face of the at least one first and/or second clamping strip is configured for fastening the first and/or second clamping strip to the at least one stator laminated core. Preferably, the contact face has one or a plurality of punctiform and/or linear contact elevations, which are configured to create a clamping connection with the stator laminated core by way of punctiform and/or linear contact.

Alternatively or additionally, the fastening device has a fastening connector for fastening the fastening device to the coil carrier segment. In particular, the fastening device has a fastening connector for fastening the fastening device to the stator circumferential structure.

Alternatively or additionally, the fastening connector comprises at least one tensioning element for the force-fitting and/or form-fitting connection of the at least one first and/or second clamping strip to the coil carrier segment. In particular, the fastening connector comprises at least one tensioning element for the force-fitting and/or form-fitting connection of the at least one first and/or second clamping strip to the stator circumferential structure.

Furthermore, it can be preferable for the fastening device to have at least one damping element for disposal between the fastening device and the stator laminated core. In particular, it is preferred that the fastening device has at least one damping element for disposal between the fastening device and the at least one first and/or second clamping strip. With the damping element, the vibration of the generator and in this respect the noise emission can be additionally reduced.

Furthermore, according to a preferred refinement of the stator segment, the at least one stator laminated core can comprise at least one first fastening groove and/or at least one second fastening groove. In particular, the at least one first fastening groove is a trapezoidal fastening groove. In particular, the at least one second fastening groove is a partially trapezoidal fastening groove. The first and/or second fastening groove is preferably configured to receive the fastening device. In particular, the first and/or second fastening groove is configured to receive in each case a first and/or second clamping strip of the at least one first and/or second clamping strip. Preferably, the first fastening groove is different from the second fastening groove.

The first and/or second fastening groove are formed in particular from the sections of the fastening grooves which configure the first and/or second stator lamination elements disposed next to one another in the axial direction. In particular, the first and/or second fastening groove have a cross section that varies in the axial direction. It can be preferred that the cross section of the first and/or second fastening groove has a trapezoidal and/or parallelogram-shaped cross section. In particular, it can be preferred that the cross section of the first and/or second fastening groove has a trapezoidal and/or left-oriented parallelogram-shaped cross section and/or right-oriented parallelogram-shaped cross section.

With stator laminated cores configured in this manner, the stator laminated cores can be mounted on the coil carrier segment in a particularly simple manner by means of the fastening device. In particular, a stator laminated core that is configured and fastened to the fastening device in this manner minimizes particularly advantageous vibro-acoustic properties. In particular, a stator with a stator laminated core fastened in this manner has comparatively low noise emission.

The stator laminated core preferably forms the first and/or second fastening groove on the radially inner stator laminated core internal face. In particular, the stator laminated core forms the second fastening groove on the first and/or second end portion of the stator laminated core.

Alternatively or additionally, it can be provided that the at least one first and/or second fastening groove preferably has at least one groove wall as a contact face for fastening the fastening device to the at least one first and/or second fastening groove. The groove wall preferably has one or a plurality of punctiform and/or linear contact elevations. In particular, the one or the plurality of punctiform and/or linear contact elevations are configured to produce a clamping connection with the fastening device via punctiform and/or linear contact.

Fastening devices of this type can be produced particularly easily and inexpensively and also have the advantage that the stator laminated core can be fastened to the coil carrier segment in a particularly simple manner. In particular, the stator laminated core can be releasably attached to the coil carrier segment, which enables a fast replacement of the stator laminated core to be exchanged when maintenance and repair work is required. At the same time, the fastening device has the advantage that the stator laminated core can be fastened to the coil carrier segment substantially without any appreciable settling, which in this respect enables the generator to be operated with minimized noise. In particular, the generator can be operated with minimized noise without, in this regard, the fastening device, for example threaded connections, having to be tightened after a certain period of operation in order to also ensure noise-minimized operation of the generator over the long term.

Some embodiments provide a stator of a generator of a wind turbine. It is to be understood that the stator is a stator for a generator. Furthermore, it is to be understood that the generator is a generator for a wind turbine.

The stator is in particular a segmented stator. The stator is preferably a stator of a segmented generator. The stator comprises an annular stator segment or a plurality of part-annular stator segments which are disposed in an annular manner. Such a stator comprises a stator segment according to the disclosure and/or features of one of the previously described embodiments of the stator segment or a combination thereof.

In terms of further advantages, design variants and design details of the stator according to the disclosure and its refinements, reference is also made to the preceding description of the corresponding features and refinements of the generator, the generator, the stator laminated core and the stator segment, as well as the following descriptions of the rotor segment, the rotor, the wind turbine and the method for manufacturing a rotor.

Some embodiments provide a rotor segment of a rotor of a generator for a wind turbine. Some embodiments provide a rotor segment of a segmented rotor of a segmented generator for a wind turbine. It is to be understood that the rotor segment is a rotor segment for a rotor, in particular for a segmented rotor. Furthermore, it is to be understood that the rotor is a rotor for a generator, in particular for a segmented generator.

The rotor segment comprises a magnet carrier segment with an annular or part-annular geometry and a rotor internal circumferential face. Furthermore, the rotor segment comprises at least one rotor laminated core, which is configured to receive at least one magnet unit and is disposed on the rotor internal circumferential face. Furthermore, the rotor segment comprises at least one magnet unit, which is disposed on the rotor laminated core. The at least one magnet unit is connected in a materially integral manner to the rotor laminated core. The materially integral connection is in particular an adhesive and/or bonded connection.

A casting compound, which at least partially encloses the magnet unit, preferably connects the magnet unit to the rotor laminated core. The casting compound is preferably disposed between the rotor laminated core of the at least one magnet unit. The casting compound by way of a casting compound height preferably extends between the rotor laminated core and the at least one magnet unit in the radial direction. The casting compound preferably extends between the rotor laminated core and the at least one magnet unit by way of a casting compound height of at least 0.05 mm, 0.1 mm, 0.2 mm, 0.3 mm, 0.4 mm, 0.5 mm, 1 mm, 1.5 mm, 2 mm, 3 mm, 4 mm or 5 mm. In particular, the casting compound extends between the rotor laminated core and the at least one magnet unit by way of a casting compound height of at most 10 mm, 7.5 mm, 5 mm, 4 mm, 3 mm, 2 mm, 1.5 mm, 1 mm, 0.5 mm, 0.4 mm, 0.3 mm, 0.2 mm or 0.1 mm.

In particular, the casting compound has damping properties. The damping effect of the casting compound preferably increases as the casting compound height between the rotor laminated core and the at least one magnet unit increases. In particular, the casting compound has better damping properties than the rotor laminated core and/or the at least one magnet unit.

Furthermore, it is preferred that the casting compound encloses the at least one magnet unit. In particular, the casting compound encases the at least one magnet unit. In particular, the at least one magnet unit is surrounded by the casting compound in such a manner that the casting compound protects the at least one magnet unit from corrosion.

In particular, the casting compound is a casting resin and/or an epoxy resin and/or a laminating resin. It can also be preferred that the casting compound comprises a polyurethane and/or a silicone.

The rotor segment preferably extends in the radial direction between a radially inner flange for fastening the rotor segment to a rotor main body flange of a bearing unit and the radially outer magnet carrier segment. The rotor segment preferably by way of a rotor support section extends between the radially inner flange for fastening the rotor segment to the rotor main body flange of the bearing unit and the radially outer magnet carrier segment. It is to be understood that the rotor segment can be configured in multiple parts or integrally. In particular, it is to be understood that the rotor segment can be formed integrally from individual rotor segments welded to one another.

The materially integral connection, in particular the connection using the casting compound, of the magnet units on the rotor laminated core has the advantage that it enables particularly low-noise operation of the generator. In particular, the casting compound has a damping effect, which additionally minimizes potential noise emissions from the generator during operation. Furthermore, such a rotor segment can be produced particularly inexpensively.

The rotor segment according to the disclosure and its refinements have features that make them particularly suitable for being used for a generator according to the disclosure and/or a wind power installation according to the disclosure and/or a method according to the disclosure and the respective refinements. In terms of further advantages, design variants and design details of the rotor segment according to the disclosure and its refinements, reference is also made to the previous description of the corresponding features and refinements of the generator, the stator laminated core, the stator segment, the stator and the following description of the corresponding features and refinements of the rotor, the wind power installation and the method for producing a rotor segment.

According to a preferred refinement, the rotor segment comprises at least one magnet cover device which is connected to the rotor laminated core, wherein a magnet unit is disposed in each case between a magnet cover device and the rotor laminated core; wherein in particular the rotor laminated core has at least one first and/or second clamping groove for the force-fitting and/or form-fitting connection of the magnet cover device to the rotor laminated core, the first clamping groove preferably being different from the second clamping groove.

Preferably, the magnet unit is disposed on the magnet cover device. In particular, the magnet unit bears against the magnet cover device at least in portions. Furthermore, it can be preferred that casting compound extends in portions between the magnet unit and the magnet cover device. In particular, the at least one magnet cover device is preferably configured as a mold for producing a rotor segment. In particular, the at least one magnet cover device is configured as a mold for casting the casting compound between the magnet unit, the at least one magnet cover device and/or the rotor laminated core.

The magnet cover device enables the magnet units to be manufactured or assembled on the rotor laminated core in a particularly cost-effective manner. In particular, the magnet cover device enables a disposal of the magnet units on the rotor laminated core, which enables particularly noise-optimized operation of a generator. Furthermore, the magnet cover device protects the magnet units from mechanical influences and corrosion.

According to a further preferred embodiment of the rotor segment, it is provided that the at least one magnet unit comprises at least one magnet block. In particular, the magnet block is a cuboid magnet block. The magnet block has grooves on at least one side of the magnet block. The grooves are configured to distribute the casting compound between the magnet block and the rotor internal circumferential face. The at least one magnet block preferably has an axial groove in an axial direction and/or a circumferential groove in a circumferential direction and/or a diagonal groove running diagonally to the axial direction and the circumferential direction. These grooves in the magnet blocks result in an improved and more durable connection between the rotor laminated core and the magnet units.

Furthermore, it is preferred that the rotor segment has a plurality of magnet units. The plurality of magnet units are disposed on the rotor internal circumferential face so as to be spaced from each other in the circumferential direction. In particular, the plurality of magnet units are disposed equidistantly in the circumferential direction on the rotor internal circumferential face. Two or more magnet units of the plurality of magnet units are preferably disposed at a spacing from one another in the axial direction. The magnet units disposed adjacent in the axial direction define a circumferential gap with a gap width. In particular, the magnet units comprise one, two or more rows of magnets. The rows of magnets are preferably disposed at a spacing from one another in the circumferential direction. In particular, the rows of magnets are disposed equidistantly from one another in the circumferential direction. In particular, a row of magnets comprises one or a plurality of magnet blocks. Preferably, a plurality of magnet blocks are disposed next to one another in the axial direction and form a magnet row.

Such a preferred embodiment of the rotor segment leads to an advantageous, uniform vibro-acoustic excitation of the generator and minimizes background noise. According to this refinement, a rotor segment for a generator that is noise-optimized during operation can also be produced particularly cost-effectively.

According to a further preferred refinement of the rotor segment, the rotor laminated core is connected in a materially integral manner to the magnet carrier segment. In particular, the rotor laminated core is connected to the magnet carrier segment with a welded joint. In addition or as an alternative, it may be preferable for the rotor laminated core to have at least one casting compound channel on an internal circumferential face of the rotor laminated core. The at least one casting compound channel is preferably configured as a groove. In particular, the at least one casting compound channel has an axial channel in an axial direction and/or a circumferential channel in a circumferential direction and/or a diagonal channel that runs diagonally to the axial direction and the circumferential direction.

The materially integral connection, in particular the welded connection, between the rotor laminated core and the magnet carrier segment can be produced in a particularly cost-effective manner. Furthermore, such a connection enables particularly low-noise operation of the generator.

The casting compound channel has the advantage that the casting compound is uniformly distributed between the rotor laminated core and the magnet units. This enables a particularly noise-optimized operation of a generator. Furthermore, the casting compound channel enables an improved and more durable connection between the rotor laminated core and the magnet units.

Some embodiments provide a rotor of a generator of a wind power installation. It is to be understood that the rotor is a rotor for a generator, in particular for a segmented generator.

The rotor is in particular a segmented rotor. Preferably, the rotor is a segmented generator rotor. The rotor comprises a rotor segment configured in an annular manner, or a plurality of rotor segments configured in a part-annular manner, which are disposed in an annular manner. Such a rotor comprises a rotor segment according to the disclosure and/or features of one of the previously described embodiments of the rotor segment or a combination thereof.

In terms of further advantages, design variants and design details of the rotor according to the disclosure and its refinements, reference is also made to the preceding description of the corresponding features and refinements of the generator, the stator segment, the stator, the rotor segment and the following descriptions of the wind power installation and the method for producing a rotor segment.

Some embodiments provide a wind power installation.

In terms of further advantages, design variants and design details of the wind power installation according to the disclosure and its refinements, reference is made to the preceding description of the corresponding features and refinements of the generator, the stator laminated core, the stator segment, the stator, the rotor segment and the rotor as well as the following descriptions of the method and the use of an auxiliary assembling tool for the manufacture of a rotor segment.

Some embodiments provide a method for producing a rotor segment. Some embodiments provide a method for producing a rotor segment as described above.

The method for producing a rotor segment comprises the following steps:
providing a magnet carrier segment with an annular or part-annular geometry and a rotor internal circumferential face; and
providing at least one rotor laminated core, which is configured to receive at least one magnet unit and is disposed on the rotor internal circumferential face; and
providing at least one magnet unit with at least one magnet block; and
disposing the at least one magnet unit on the rotor laminated core; and
connecting in a materially integral manner the at least one magnet unit to the rotor laminated core.

The method according to the disclosure and its possible refinements have features or method steps that make them particularly suitable for being used for a generator according to the disclosure and/or a wind power installation according to the disclosure and/or a rotor segment according to the disclosure and/or a rotor according to the disclosure and the respective refinements. In terms of further advantages, design variants and design details of the method according to the disclosure and its refinements, reference is made to the preceding description of the corresponding aspects and refinements of the generator, the stator laminated core, the stator segment, the stator, the rotor segment, the rotor and/or the wind power installation.

According to a preferred embodiment of the method, it is provided that the step of connecting in a materially integral manner the at least one magnet unit to the rotor laminated core comprises casting the at least one magnet unit on the rotor laminated core, so that a casting compound at least partially encloses the magnet unit.

Furthermore, it can be preferred that the method preferably comprises the following steps:
providing at least one magnet cover device; and/or
providing an auxiliary assembling tool, wherein the auxiliary assembling tool preferably is composed of or comprises steel, and wherein the auxiliary assembling tool is preferably a negative mold of the at least one magnet cover device and/or the rotor laminated core, in particular the internal circumferential face of the rotor laminated core; and/or
fastening the at least one rotor laminated core to the rotor internal circumferential face of the magnet carrier segment; and/or
fastening the at least one magnet cover device to the rotor laminated core; and/or
disposing the auxiliary assembling tool on the magnet carrier segment, so that the auxiliary assembling tool encloses the at least one magnet cover device and/or the at least one rotor laminated core; and/or
inserting the at least one magnet block of the at least one magnet unit into the at least one magnet cover device; and/or
casting at least the at least one magnet cover device with the at least one magnet block inserted therein and the rotor laminated core with a casting compound, wherein the casting with the casting compound takes place in particular counter to the force of gravity from bottom to top; and/or
curing the casting compound; and/or
removing the auxiliary assembling tool.

Inserting the at least one magnet block of the at least one magnet unit into the at least one magnet cover device comprises, in particular, loading the auxiliary assembling tool, preferably magnet feed ducts of the auxiliary assembling tool, and/or feeding the magnet blocks of the at least one magnet unit, which are disposed in the magnet feed ducts of the auxiliary assembling tool, into the at least one magnet cover device with a sliding device, in particular in an axial direction. Furthermore, the method can comprise a staggered disposal of the auxiliary assembling tool on the magnet carrier segment in order to feed magnet blocks into magnet cover devices that do not yet have magnet blocks according to the method described above.

The method according to the disclosure and its possible refinements have features or method steps that make them particularly suitable for being used for a segmented generator according to the disclosure and/or a rotor segment according to the disclosure and/or a rotor according to the disclosure and/or a wind power installation according to the disclosure and the respective refinements. In terms of further advantages, design variants and design details of these further aspects and their possible refinements, reference is also made to the previously given description of the corresponding features and refinements of the generator, the stator laminated core, the stator segment, the stator, the rotor segment, the rotor, the wind power installation and/or the use of an auxiliary assembling tool for the production of a rotor segment.

Some embodiments use an auxiliary assembling tool for producing a rotor segment, in particular for producing a rotor segment as described above, preferably for disposing at least one magnet unit on a rotor laminated core and for connecting in a materially integral manner the at least one magnet unit on the rotor laminated core, wherein the materially integral connection is in particular a casting of the at least one magnet unit on the rotor laminated core, so that a casting compound encloses the magnet unit at least partially.

The use according to the disclosure has features or method steps that make it particularly suitable for being used for a rotor segment according to the disclosure and/or a rotor according to the disclosure and/or a generator according to the disclosure as well as the respective refinements. In terms of further advantages, design variants and design details of these further aspects and their possible refinements, reference is also made to the previously given description of the corresponding features and refinements of the generator, the stator laminated core, the stator segment, the stator, the rotor segment, the rotor, the wind power installation and/or the method.

### BRIEF DESCRIPTION OF THE SEVERAL VIEWS OF THE DRAWINGS

Embodiments will be explained by way of example with the aid of the appended figures.

FIG. 1 shows a schematic, three-dimensional view of a preferred embodiment of a wind power installation in an operating state.

FIG. 2 shows a schematic, three-dimensional view of a preferred embodiment of a segmented generator.

FIG. 3 shows a schematic, three-dimensional view of a preferred embodiment of a generator segment of a segmented generator shown in FIG. 2.

FIG. 4 shows a schematic, three-dimensional view of a preferred embodiment of a stator laminated core with coil units disposed thereon.

FIG. 5 shows a schematic, three-dimensional section of a preferred embodiment of a stator lamination stack of the stator laminated core shown in FIG. 4.

FIG. 6 shows a schematic, three-dimensional detailed view of the stator lamination stack shown in FIG. 5.

FIG. 7 shows a schematic, three-dimensional detailed view of a preferred embodiment of a stator segment.

FIG. 8 shows a schematic, three-dimensional detailed view of a further preferred embodiment of a stator segment.

FIG. 9 shows a schematic, three-dimensional view of a preferred arrangement of two stator laminated cores disposed adjacent to one another in the circumferential direction, with coil units disposed thereon.

FIG. 10 shows a schematic, three-dimensional detailed view of the disposal of adjacent stator laminated cores shown schematically in FIG. 9.

FIG. 11 shows a schematic lateral view of a preferred embodiment of a stator segment.

FIG. 12 shows a detailed view of the stator segment shown in FIG. 11.

FIG. 13 shows a schematic, three-dimensional view of a possible preferred embodiment of a first stator lamination element of the stator segment shown in FIG. 11.

FIG. 14 shows a schematic, three-dimensional view of a preferred embodiment of a rotor laminated core with magnet units disposed thereon.

FIG. 15 shows a schematic, three-dimensional detailed view of the view of the rotor laminated core shown schematically in FIG. 14, with magnet units disposed thereon.

FIG. 16 shows a schematic, three-dimensional detailed view of the view of the rotor laminated core shown schematically in FIG. 15, with magnet units disposed thereon.

FIG. 17 shows a schematic, three-dimensional view of a further preferred embodiment of a rotor laminated core with magnet units disposed thereon.

FIGS. 18a and 18b show a schematic, three-dimensional view of an embodiment of an auxiliary assembling tool in front and rear views.

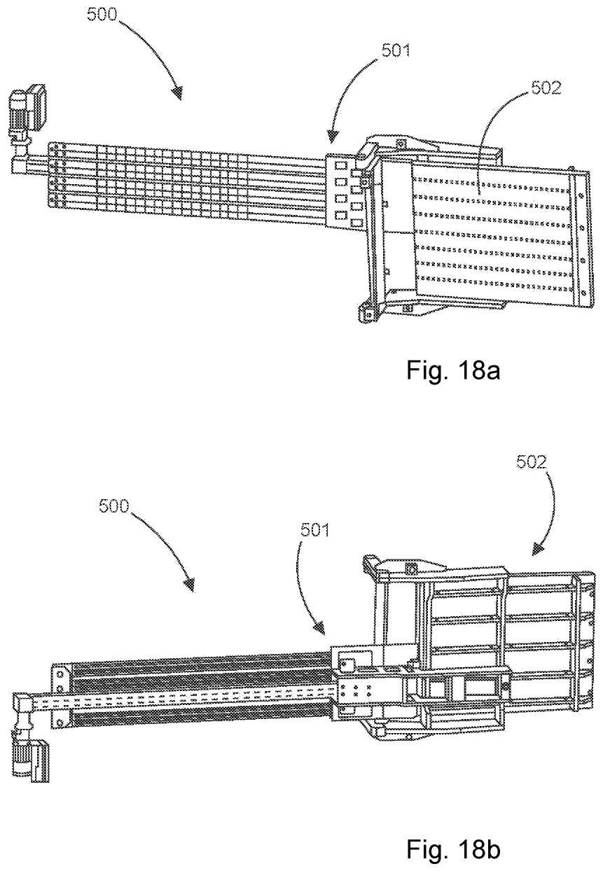

FIGS. 19a and 19b show a schematic, three-dimensional detailed view of the front and rear view of the auxiliary assembling tool shown in FIGS. 18a and 18b.

FIG. 20 shows a schematic flowchart showing by way of example steps of a preferred embodiment of a method for producing a rotor segment of a wind power installation.

FIG. 21 shows a schematic flowchart showing by way of example steps of a further preferred embodiment of a method for producing a rotor segment of a wind power installation.

In the figures, identical or substantially functionally identical or similar elements are denoted by the same reference designations. If general reference is made to a generator, rotor or stator in the present description of the figures, this in principle includes a segmented generator, segmented rotor or segmented stator, unless this is expressly described otherwise.

### DETAILED DESCRIPTION

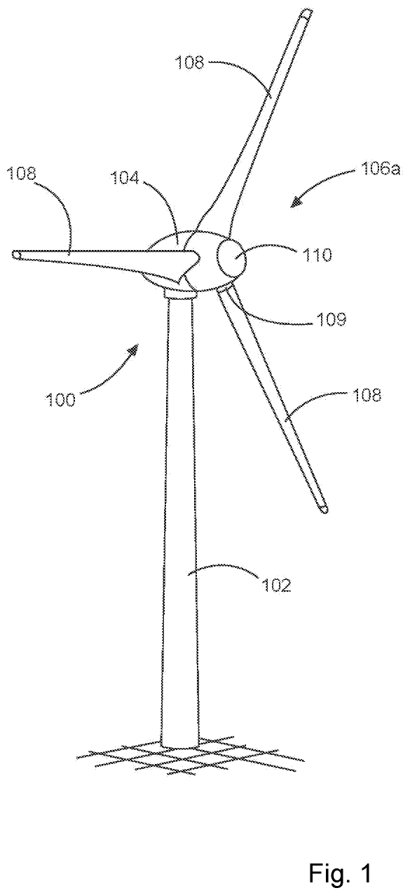

FIG. 1 shows a schematic three-dimensional view of an embodiment of a wind power installation. FIG. 1 shows in particular a wind power installation 100 with a tower 102 and a nacelle 104. An aerodynamic rotor 106a with three rotor blades 108 and a spinner 110 is disposed on the nacelle 104. During operation, the aerodynamic rotor 106a is set in rotation by the wind and thereby drives a generator 1, in particular a rotor 106 of the generator 1. The generator 1 is disposed in particular outside the nacelle 104. The tower 102 has, in particular, wind power installation steel tower ring segments with flange segments. As a result, the tower 102 is constructed by means of components that are easy to transport and that can also be connected with great precision and with little effort.

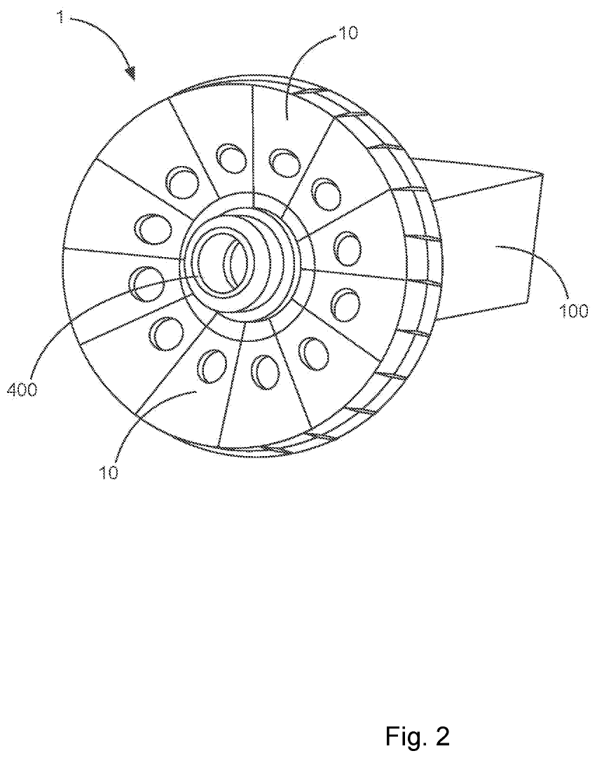

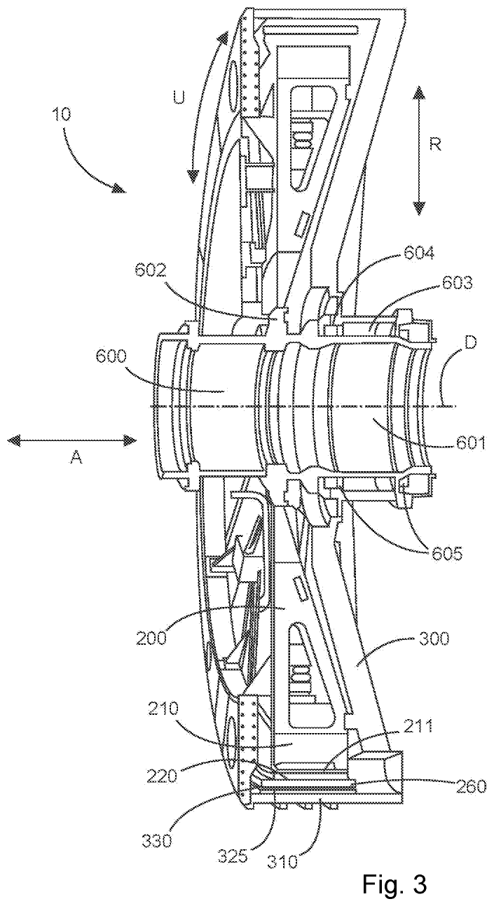

FIG. 2 shows a segmented generator 1, which has two generator segments 10, in a schematic, three-dimensional view. The segmented generator shown in FIG. 2 is suitable, for example, for a wind power installation illustrated in FIG. 1. FIG. 3 shows a generator segment 10 of the segmented generator 1 illustrated in FIG. 2, in a schematic, three-dimensional view. The generator segment 10 has a stator segment 200 and a rotor segment 300.

In this preferred embodiment, the generator segment shown in FIG. 3 has an annular stator segment 200. The stator segment 200 comprises a coil carrier segment 210 with an annular or part-annular geometry and a stator circumferential structure 211. Furthermore, the stator segment 200 comprises at least one stator laminated core 220, as has been described in detail, for example, with reference to FIGS. 2 to 6. The stator laminated core 220 is disposed on the stator circumferential structure 211 and receives a plurality of coil units 260.

The stator segment 200 preferably extends in the radial direction R between a radially inner flange for fastening the stator segment 200 to the stator main body flange 602 of a stationary bearing part 601 of a bearing unit 600 and a radially outer coil carrier segment 210. In the present preferred embodiment, the stator segment 200 is formed as a shell structure extending in a truncated pyramid shape from the flange to the coil carrier segment 210, with the cross section of the stator segment 200 increasing from the flange to the coil carrier segment 210. The at least one stator laminated core 220 is disposed on the coil carrier segment 210. At least one coil unit 260 is in turn disposed on the at least one stator laminated core 220. In the preferred embodiment shown here, the at least one stator laminated core 220 and/or the at least one coil unit 260 form a stator external circumferential face 250.

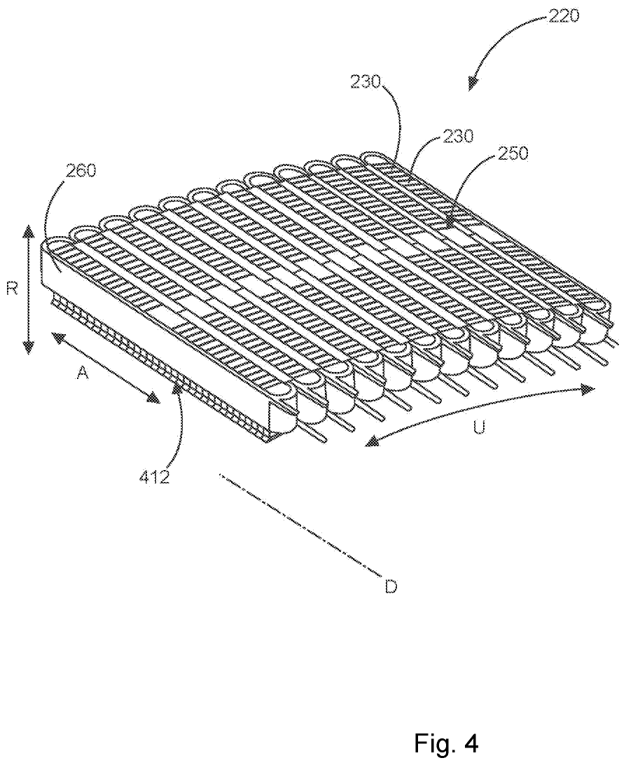

FIG. 4 shows a schematic, three-dimensional view of an embodiment of a stator laminated core 220. The stator laminated core 220 is suitable for receiving at least one coil unit 260 of a stator segment 200 of a stator 109 of a generator 1, as is illustrated schematically in FIG. 2, for example. In the present preferred embodiment, twelve coil units are disposed on the stator laminated core 220. The stator laminated core 220 has a plurality of stator lamination stacks 230. The stator lamination stacks 230 are disposed spaced apart from one another in an axial direction A parallel to an axis of rotation D.

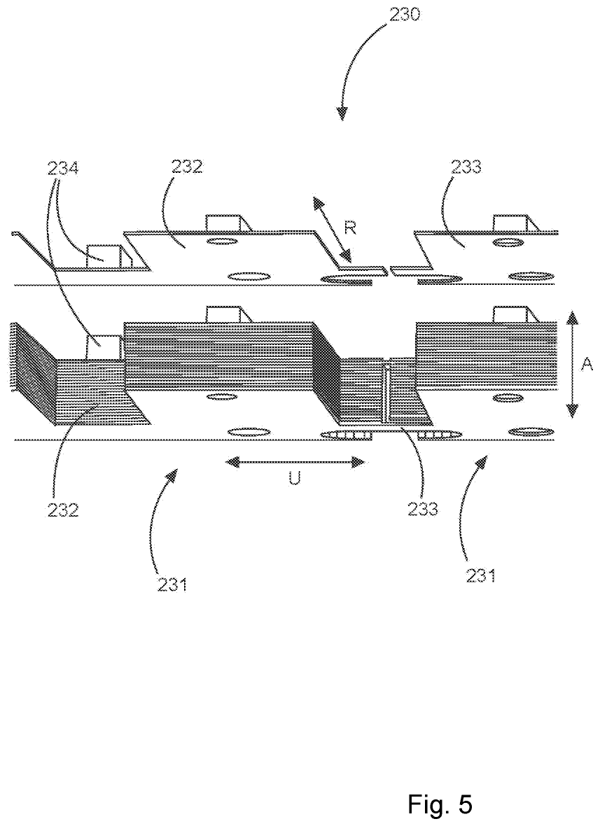

FIG. 5 shows a schematic, three-dimensional section of an embodiment of such a stator laminated core with a plurality of stator lamination stacks 230 with two lamination stack units 231. It can be seen that adjacent stator lamination stacks 230 are spaced from one another in the axial direction. For this purpose, a spacer element 234 is disposed between adjacent stator lamination stacks 230.

Furthermore, FIG. 5 shows a schematic, three-dimensional section of an embodiment of such a stator lamination stack 230 with two lamination stack units 231. The two or more lamination stack units 231 are disposed at a spacing from one another in a circumferential direction U. The lamination stack units 231 have a plurality of first stator lamination elements 232 which are disposed stacked next to one another in the axial direction A. It can furthermore be seen that the stator lamination stack 230 shown schematically in FIG. 5 has two second stator lamination elements 233, which differ from the first stator lamination element 232. The second stator lamination elements 233 respectively connect lamination stack units 231 adjacent in the circumferential direction of the two or more lamination stack units 231 to one another.

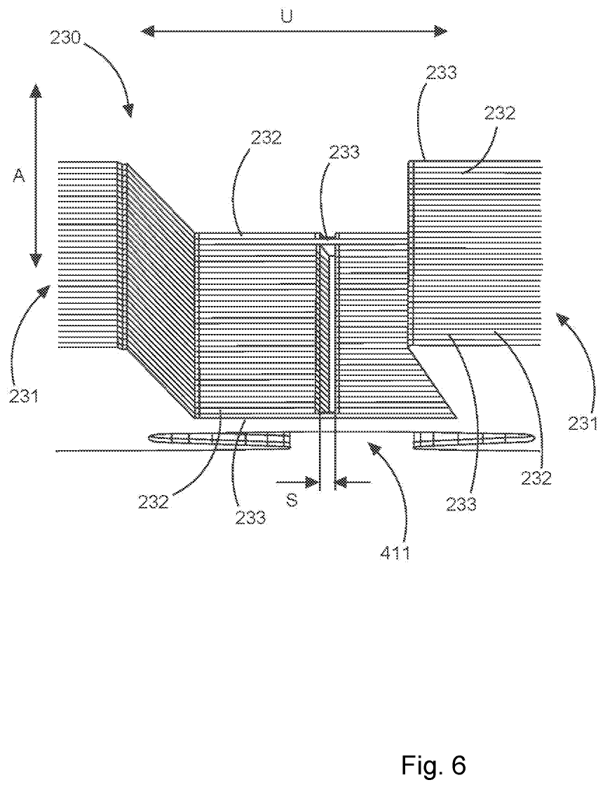

FIG. 6 is a schematic, three-dimensional detailed view of the stator lamination stack 230 shown in FIG. 5. From the detailed illustration of FIG. 6 it can be derived in the lower part of the image that a second stator lamination element 233 as the outermost lamination element connects the two lamination stack units 231 shown in fragments. In the upper portion of the detailed illustration of FIG. 6 it can be seen that a second stator lamination element 233, which is not the outermost lamination element, connects the two lamination stack units 231 shown in fragments to one another. In the lamination stack unit 231 illustrated on the left in FIG. 6, a first stator lamination element 232 forms the outermost lamination element, and in the lamination stack unit 231 shown on the right a second stator lamination element 232 forms the outermost lamination element. This second stator lamination element 232 connects the lamination stack unit 231, illustrated on the right in FIG. 6, to a further lamination stack unit 231 (not illustrated) which in turn is disposed so as to be spaced apart in the circumferential direction U.

The first stator lamination elements 232 extend in the circumferential direction U by way of a first lamination length and the second stator lamination elements 233 by way of a second lamination length. It should be understood that the second lamination length of the second stator lamination elements 233 extends more than twice as far in comparison to the first lamination length of the first stator lamination elements 232. This is due to the disposal of adjacent lamination stack units 231 spaced apart in the circumferential direction U at a lamination stack spacing S. The lamination stack units 231 disposed adjacent in the circumferential direction are preferably disposed at a lamination stack distance S from one another of more than 0 mm and less than 10 mm. The lamination stack units 231 disposed adjacent to one another are preferably disposed at a spacing from one another at a lamination stack spacing S of approximately 2 mm.

In particular, it is preferred that the stator laminated core 220 illustrated schematically in FIG. 2, or the stator lamination stack 230 thereof, in the circumferential direction U extend with an arc angle of approximately 15°±1°. Furthermore, it is preferred that the first stator lamination elements 232 in the circumferential direction U extend with an arc angle of approximately 5°±1°. It is preferable for the second stator lamination elements 233 to extend in the circumferential direction U with an arc angle of approximately 5°±1°. According to such a preferred embodiment, a stator lamination stack 230 of the stator laminated core 220 in the circumferential direction U comprises three adjacently disposed lamination stack units 231, on each of which four coil units 260 are disposed.

Furthermore, in the axial direction A, the first stator lamination elements 232 extend by way of a first lamination width and the second stator lamination elements 233 by way of a second lamination width. It is preferred that the first lamination width corresponds to the second lamination width.

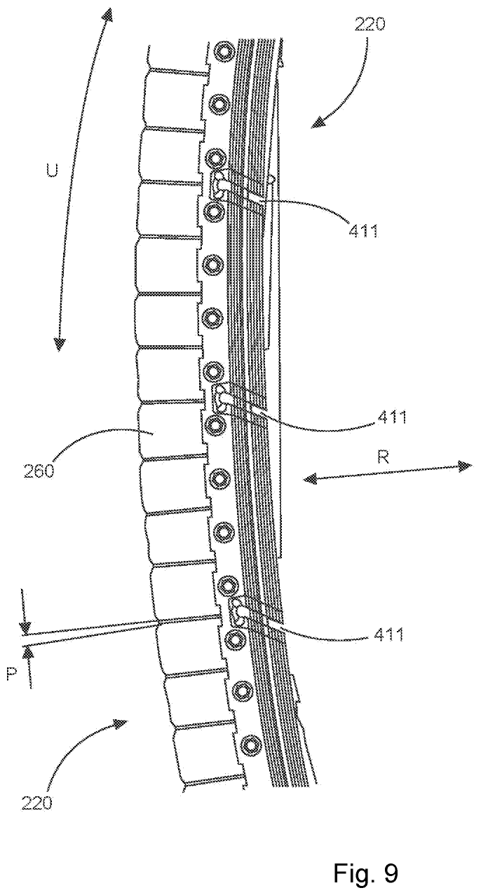

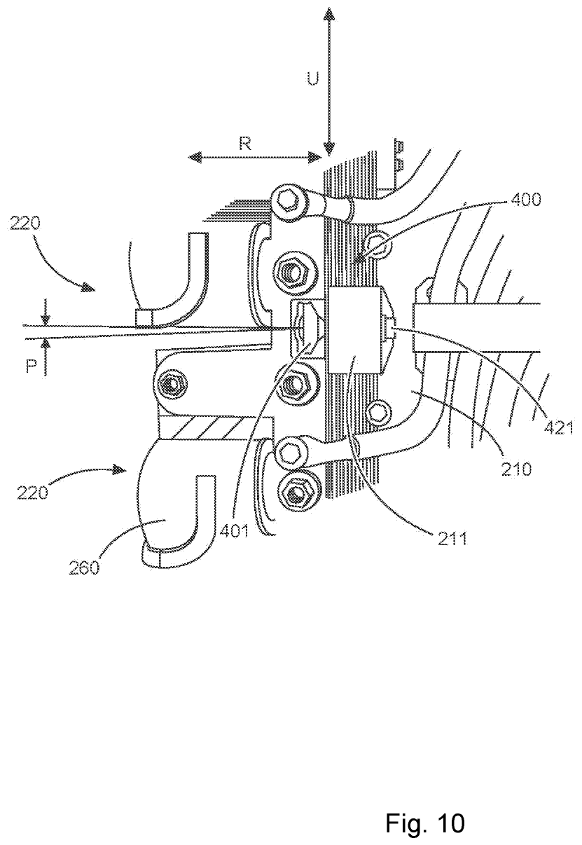

It can be seen in FIGS. 9 and 10 that stator laminated cores 220 or stator lamination stacks 230 disposed adjacent in the circumferential direction U are disposed at a laminated core spacing P from one another. In the preferred embodiment of the stator laminated core 220 illustrated in FIGS. 9 and 10, it is provided that the lamination stack spacing S corresponds to the laminated core spacing P.

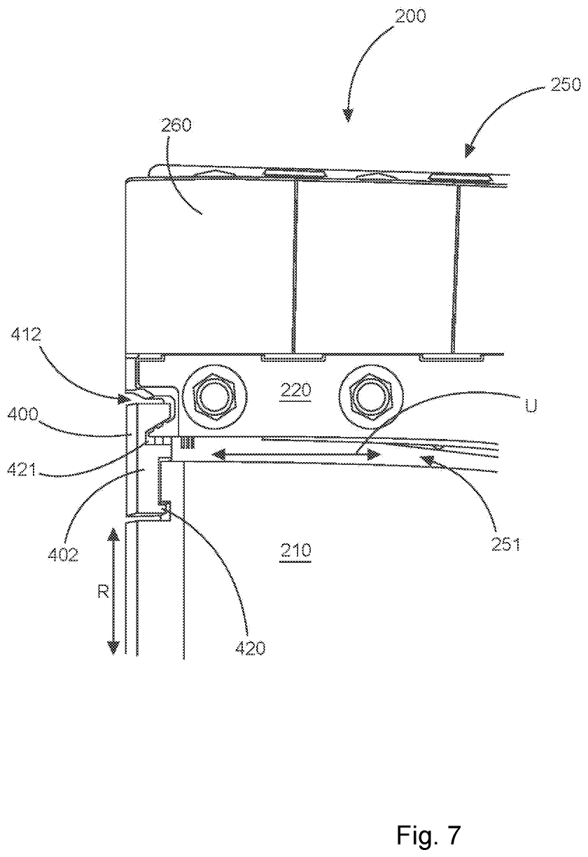

Furthermore, the stator segment can preferably have a fastening device 400 for fastening the at least one stator laminated core 220 to the coil carrier segment 210. For this purpose, the fastening device 400 is embodied as a clamping device, by means of which the at least one stator laminated core 220 is connected to the coil carrier segment in a force-fitting and/or form-fitting manner. In the detailed views of an embodiment of a stator segment 200 illustrated schematically in FIGS. 7, 8 and 10, preferred embodiments of the fastening device 400 configured as a clamping device are depicted.

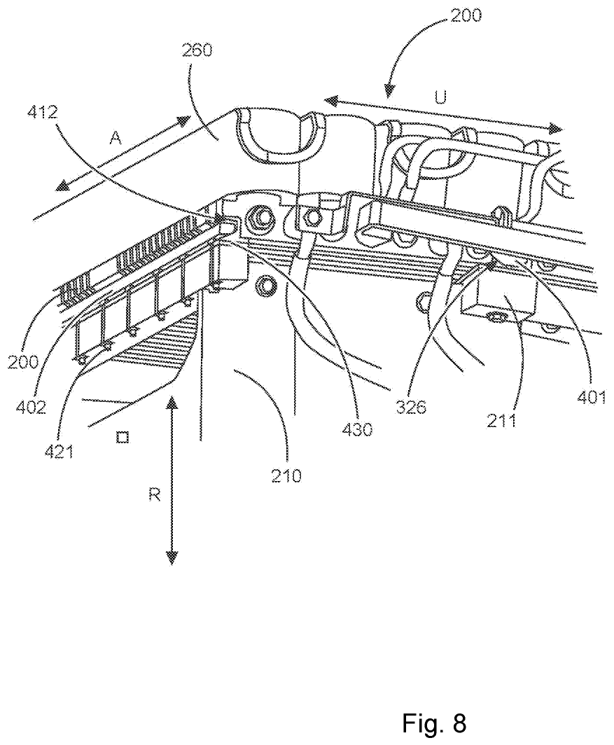

For example, FIGS. 8 and 10 show a preferred embodiment of the fastening device 400. The fastening device shown there has a first clamping strip 401, which is of trapezoidal configuration. Furthermore, FIG. 8 shows a further preferred embodiment of the fastening device 400, which is shown schematically in detail in FIG. 7. In this further preferred embodiment of the fastening device 400, a second clamping strip 402 is provided, which differs from the first clamping strip 401. In the preferred embodiment of the fastening device 400 illustrated in FIGS. 7 and 8, the second clamping strip 402 is configured as a partially trapezoidal clamping strip.

Both the first and the second clamping strip 401, 402 are configured for the force-fitting and/or form-fitting fastening of the fastening device 400 to the at least one stator laminated core 220. In order to fasten the stator laminated core 220 to a stator circumferential structure 211 of the coil carrier segment 210, the stator laminated core 220 has at least one first fastening groove 411 and/or one second fastening groove 412. The first and/or the second fastening groove 411 are/is formed substantially on the radially inner stator internal circumferential face. Illustrated schematically in FIGS. 5, 6 and 9 is a first fastening groove 411 which is trapezoidal. A second fastening groove 412, which differs from the first fastening groove 411 and has a partially trapezoidal design, is illustrated in FIGS. 7 and 8. The stator laminated core 220 preferably forms the second fastening groove 412 on a first and a second end portion 220a,b. It should be understood that in these embodiments, the first trapezoidal-shaped fastening groove 411 is configured to receive the first trapezoidal-shaped clamping strip 401 and the second partially trapezoidal-shaped fastening groove 412 is configured to receive the second trapezoidal-shaped clamping strip 402.

The first and the second clamping strip 401, 402 each have a contact face for fastening the first and/or the second clamping strip 401, 402 to the stator laminated core 220. The first and the second fastening grooves have at least one groove wall as a contact face in order to fasten the first and second clamping strips 401, 402, respectively. For the preferred embodiments of the clamping strips 401, 402 illustrated in the figures, it is provided that their contact faces have a plurality of punctiform and/or linear contact elevations. This makes it possible to produce a force-fitting and form-fitting connection between the clamping strips 401, 402 and the fastening grooves 411, 412. Such contact faces are illustrated schematically in FIGS. 5 and 7.

In order to fasten the stator laminated core 220 to the stator circumferential structure 211 with the fastening device 400, it is provided that the fastening device 400 has tensioning elements 421 configured as screws. These tensioning elements 421 can be used to connect the first and second clamping strip 401 to the coil carrier segment 210 or its stator circumferential structure 211 in a force-fitting and/or form-fitting manner. This becomes particularly clear in terms of the first clamping strip 401 in FIGS. 8 and 10; in terms of the second clamping strip 402 this is shown schematically in FIG. 8.

It can also be preferred that the fastening device 400 additionally or alternatively has a fastening connector 420 which enables a form-fitting connection of the first and/or the second clamping strip 401, 402 to the stator circumferential structure 211. This is shown by way of example in FIG. 7, in terms of the second clamping strip 402. For this purpose, the second clamping strip 402 has a protrusion in the circumferential direction U, which form-fittingly engages in a corresponding groove on the coil carrier segment 210 or the stator circumferential structure 211 to connect the stator laminated core 220 to the stator circumferential structure 211. Furthermore, tensioning elements are disposed in the second fastening groove 412, which align the stator laminated core 220 in relation to the coil carrier segment 210 and enable a force-fitting and/or form-fitting connection.

In particular, a damping element 430 disposed between the fastening device 400 and the first and/or the second clamping strip 401, 402 can be disposed to reduce noise emissions. Such a damping element in FIG. 8 is disposed schematically between the second clamping strip 402 and the stator laminated core 220.

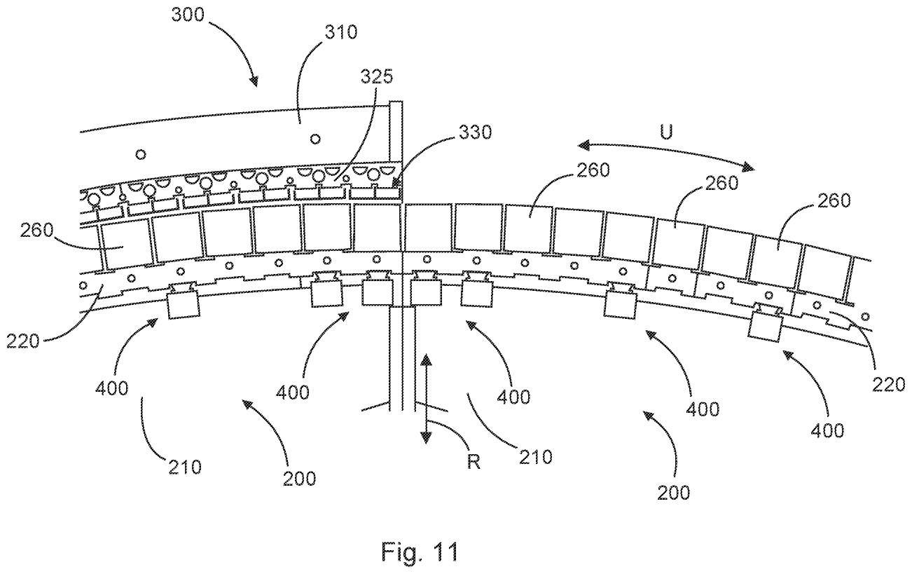

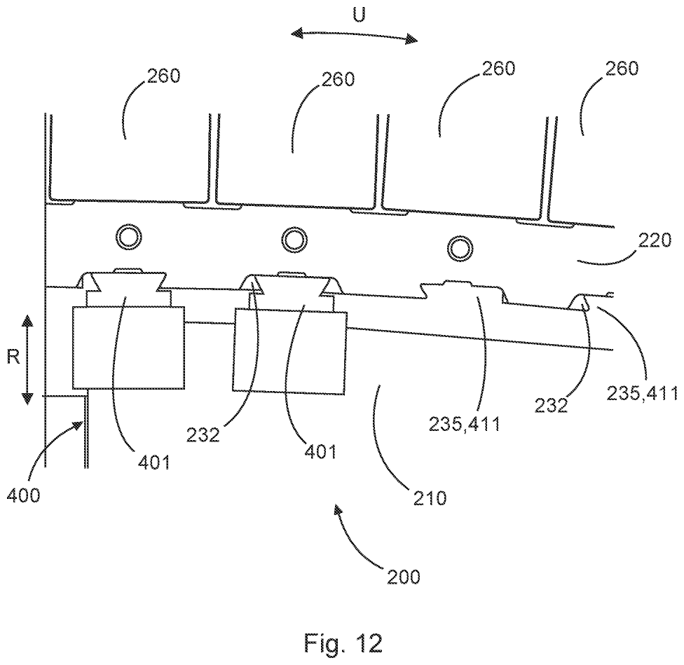

FIG. 11 shows a schematic lateral view of another preferred embodiment of a stator segment 200. The stator segment 200 substantially has the features of the stator segment(s) 200 described above. The stator segment illustrated in FIG. 11 differs from the other embodiments in that the stator laminated core 220 has modified first fastening grooves 411. The first fastening grooves 411 have a variable cross section in the axial direction A. Substantially, the cross section of the first fastening groove varies in the axial direction A between a trapezoidal cross section and a parallelogram-shaped cross section oriented toward the left and toward the right. This is highlighted by the detailed view in FIG. 12 of the stator segment illustrated in FIG. 11. It can be seen that the stator lamination elements 232 of the lamination stack units 231 of the stator lamination stack 230 each have different recesses 235, which are disposed next to one another in the axial direction A and form the first fastening grooves 411, in which the clamping strips 401 can be fastened. These recesses 235 have a trapezoidal cross section and a parallelogram-shaped cross section oriented to the left and to the right. It is provided here that the stator lamination elements 232 disposed adjacent in the axial direction A are disposed offset in relation to one another in the circumferential direction U by two recesses 235 in each case.

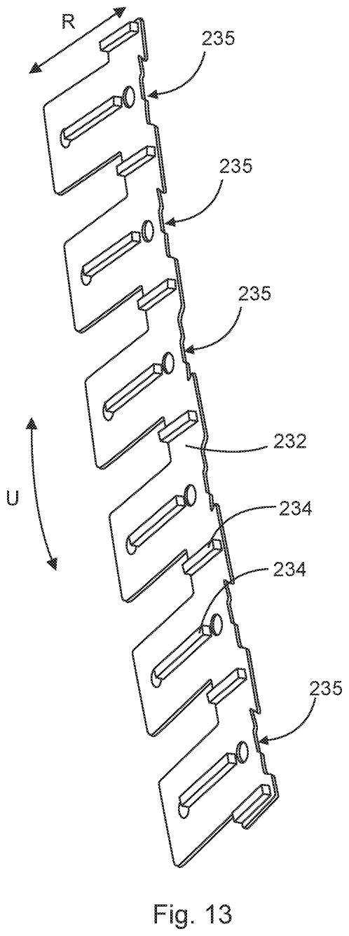

FIG. 13 shows a schematic, three-dimensional view of a possible preferred embodiment of a stator lamination element 232 with spacer elements 234. It can be seen that the stator lamination element 232 has a plurality of recesses 235 on an inner end face in the radial direction, which extend from the inner end face to an outer end face in the radial direction R in relation to the inner end face. The stator lamination element 232 has a plurality of such recesses 235 which are disposed equidistantly from one another in the circumferential direction U. It can be seen that the stator lamination element 232 has a plurality of parallelogram-shaped cross sections oriented toward the right and toward the left. In the preferred embodiment shown here, it is provided that two recesses 235 with parallelogram-shaped cross sections oriented to the right are disposed in the circumferential direction alternating with two parallelogram-shaped cross sections oriented to the left.

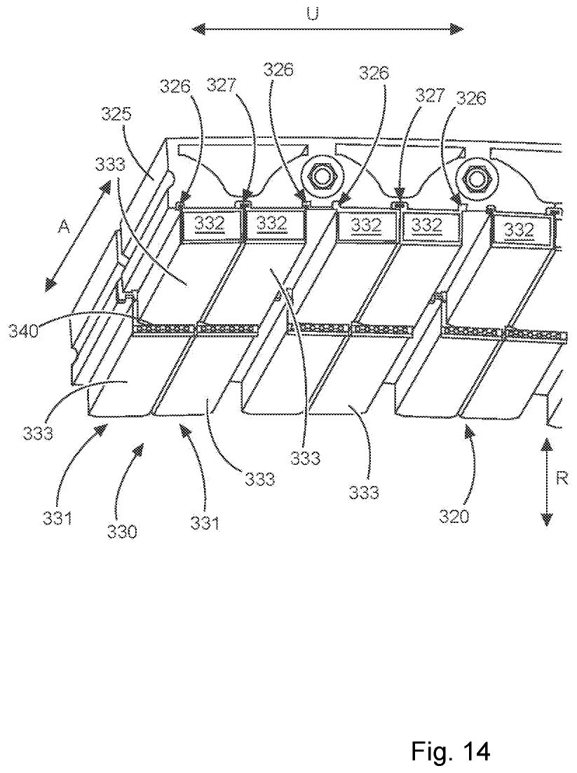

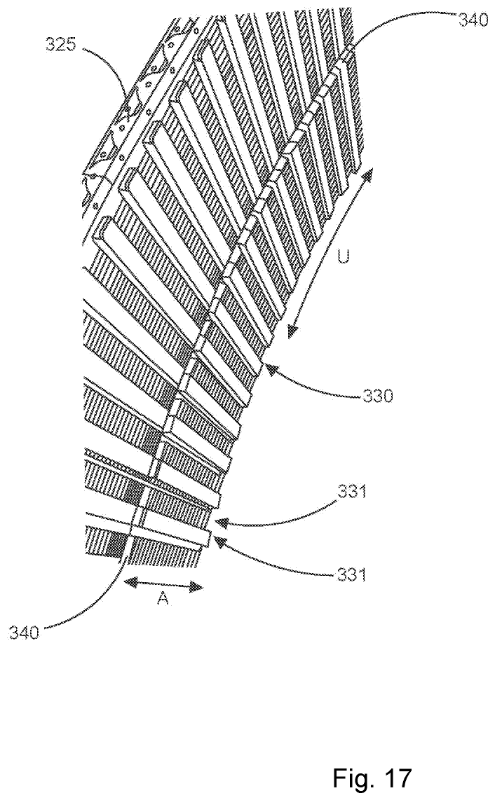

In the preferred embodiment of the generator segment 10 illustrated in FIG. 3, the annular rotor segment 300 extends in the radial direction between a radially inner flange for fastening the rotor segment 300 to a rotor main body flange 604 of a rotating bearing part 603 of a bearing unit 600 and a radially outer magnet carrier segment 310. The rotating bearing part 603 by way of rolling elements 605 is rotatably mounted in relation to the stationary bearing part 601. The at least one rotor laminated core 325 is disposed on the magnet carrier segment 310, as is illustrated by way of example in FIGS. 11, 14 and 17. The magnet carrier segment 310 and the at least one rotor laminated core 325 are preferably welded to one another. At least one magnet unit 330 is in turn disposed on the at least one rotor laminated core 325. In the preferred embodiment illustrated here, the at least one magnet unit 330 forms a rotor internal circumferential face 320.

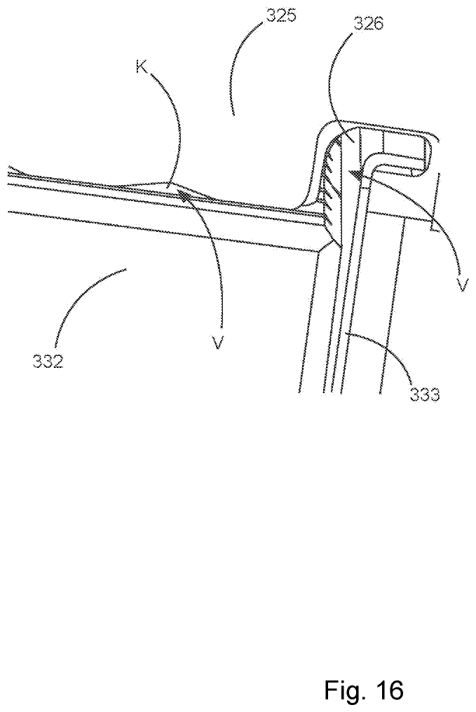

It is envisaged that the rotor segment 300 has a plurality of magnet cover devices 333 which partially enclose magnet units 330 and are connected to the rotor laminated core 325. This is shown, for example, in FIGS. 11 and 14 to 17. For this purpose, the rotor laminated core 325 has first and second clamping grooves 326, 327 which extend in the axial direction. The magnet cover devices 333 are inserted into these first and second clamping grooves 326, 327 in the axial direction A. The first and second clamping grooves 326, 327 enable a force-fitting and/or form-fitting connection of the magnet cover device 333 to the rotor laminated core 325. It can be seen that the first clamping groove 326 differs from the second clamping groove 327. The first clamping groove 326 is preferably configured as an L-shaped groove and the second clamping groove 327 is preferably configured as a T-shaped groove. These different designs of the first and second clamping grooves 326, 327 in the rotor laminated core 325 are illustrated schematically in FIGS. 11, 14 and 15.

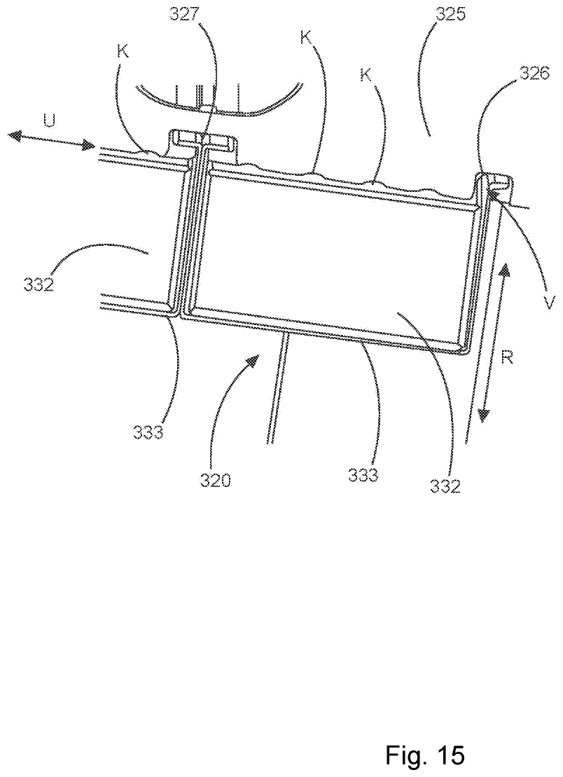

The rotor segment 300 comprises a plurality of magnet units 330 which are disposed equidistantly from one another in the circumferential direction U. Furthermore, magnet units 330 disposed adjacent in the axial direction A are disposed spaced apart from one another in the axial direction A, so that a circumferential gap 340 having a gap width is defined. It is also to be understood that the magnet units 330 in the preferred embodiments of the rotor segment illustrated in the figures have two rows of magnets 331 which are disposed at a spacing from one another in the circumferential direction U. The special embodiments of the magnet units 330 are shown, for example, in FIGS. 9 and 15.

The magnet units 330 are disposed on the rotor laminated core 325 and are materially integrally connected to the rotor laminated core 325. For this purpose, a casting compound V encloses the magnet units 330 at least partially. So that the casting compound V is distributed uniformly between the magnet units 330, in particular the magnet blocks 332, and the rotor-stator laminated core 325, the magnet blocks 332 include grooves on one side of the magnet block or on a surface portion. In particular, the grooves formed on the magnet blocks 332 are axial grooves in the axial direction A, circumferential grooves in the circumferential direction, and diagonal grooves running diagonally to the circumferential direction and axial direction. In FIG. 10, the axial grooves can be seen on a side of the magnet block that faces the rotor internal circumferential face 320. Axial grooves and diagonal grooves are not shown in the figures of the preferred embodiments. Furthermore, the distribution of the casting compound V between the magnet units 330 and the rotor laminated core 325 is improved by casting compound channels K, which are formed by the rotor laminated core 325. Such casting compound channels K are illustrated in FIG. 15, for example. The embodiment of the rotor laminated core 325 that is exemplary there substantially has casting compound channels K that extend in the axial direction A. It can also be preferred that the rotor laminated cores 325 additionally and/or alternatively have casting compound channels K, which substantially extend in the circumferential direction U and/or in the diagonal direction, diagonally to the circumferential direction U and the axial direction A.

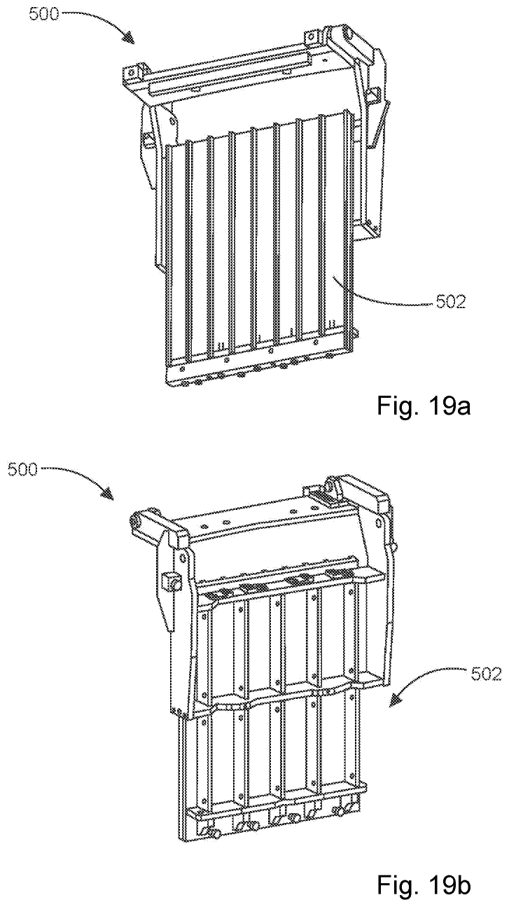

An auxiliary assembling tool 500 is used to connect in a materially integral manner the magnet units 330 to the rotor laminated core 325 with the casting compound K. The auxiliary assembling tool 500 substantially represents a negative mold of the magnet cover device 333 disposed on the rotor laminated core 325. FIGS. 19a-19b show a preferred embodiment of such an auxiliary assembling tool 500. For the casting of the casting compound K, i.e., for the materially integral connection of the magnet units 330 to the rotor laminated core 325, the auxiliary assembling tool 500 is placed on the rotor segment 300 and the auxiliary assembling tool 500 is loaded with the magnet blocks 332 via magnet feed ducts. The magnet blocks 332 are fed to the magnet cover devices 333 in the axial direction A with the aid of the magnet feed ducts 502 by a sliding device 501 of the auxiliary assembling tool 500. The auxiliary assembling tool 500 is then disposed offset in the circumferential direction U relative to the rotor segment 300 and, according to the procedure described above, the auxiliary assembling tool 500 is fitted with the magnet blocks 332, which then—as also described above—are fed to the still free magnet cover devices 333 in the axial direction A. This is repeated until all rotor segment magnet cover devices 333 are populated with magnet blocks 332.

The auxiliary assembling tool 500, in particular the magnet feed ducts, are made of steel. This has the effect that the magnet blocks 332 supplied to the magnet cover devices 333 bear flat against the magnet cover devices 333 during delivery and are not in contact with the rotor laminated core during delivery. The magnetic forces of the magnet blocks 332 act toward the auxiliary assembling tool 500 so that the magnet blocks 332 can be supplied to the magnet cover devices 333 spaced apart by a gap in the radial direction. This gap also serves as an additional channel into which the casting compound V can rise when the rotor segment 300 is produced.

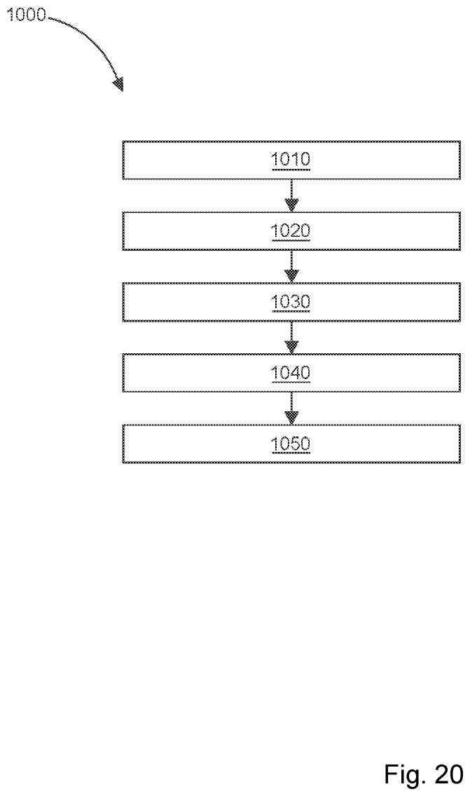

FIG. 20 shows a schematic flowchart showing by way of example steps of a preferred embodiment of a method 1000 for producing a rotor segment 300.

The method 1000 for producing a rotor segment 300 comprises providing 1010 a magnet carrier segment 310 with an annular or part-annular geometry and a rotor internal circumferential face 320, providing 1020 at least one rotor laminated core 325, which is configured to receive at least one magnet unit 330 and on the rotor internal circumferential face and providing 1030 at least one magnet unit 330 with at least one magnet block 332. Furthermore, the method 1000 comprises disposing 1040 the at least one magnet unit 330 on the rotor laminated core 325 and connecting in a materially integral manner 1050 the at least one magnet unit 330 to the rotor laminated core 325.

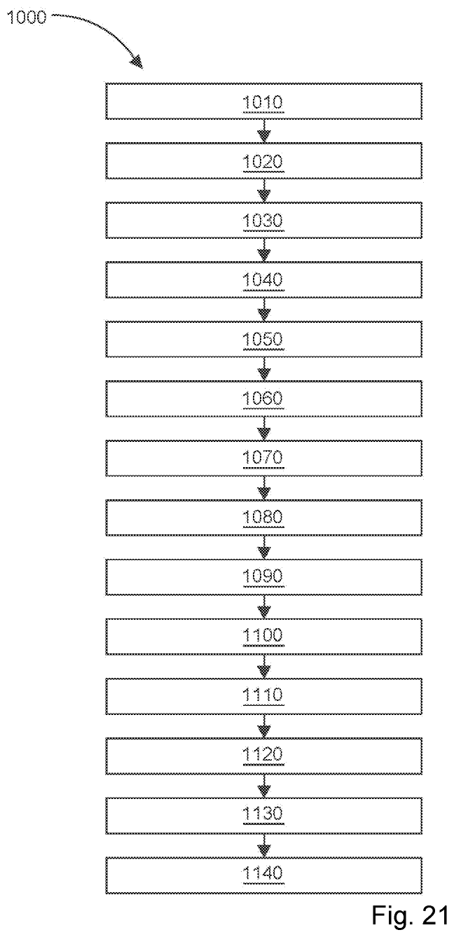

FIG. 21 shows a schematic flowchart showing by way of example steps of a further preferred embodiment of a method 1000 for manufacturing a rotor segment 300.

According to this further preferred embodiment of the method 1000, the step of materially integrally connecting the at least one magnet unit 330 to the rotor laminated core 325 preferably includes casting the at least one magnet unit 330 to the rotor laminated core 325, so that a casting compound V at least partially encloses the magnet unit 330.

Furthermore, this further preferred embodiment of the method 1000 comprises providing 1060 at least one magnet cover device 333; and/or providing 1070 an auxiliary assembling tool 500, wherein the auxiliary assembling tool 500 preferably consists of or comprises steel, and wherein the auxiliary assembling tool 500 is preferably a negative mold of the at least one magnet cover device 333 and/or the rotor laminated core, in particular the internal circumferential face of the rotor laminated core. In particular, this further embodiment of the method 1000 includes fastening 1080 the at least one rotor laminated core 325 to the rotor internal circumferential face 320 of the magnet carrier segment 310 and/or fastening 1090 the at least one magnet cover device 333 to the rotor laminated core 325. Additionally or alternatively, the method 1000 can include disposing 1100 the auxiliary assembling tool 500 on the magnet carrier segment 310, so that the auxiliary assembling tool encloses the at least one magnet cover device 333 and/or the at least one rotor laminated core 325. Furthermore, the method 1000 preferably includes inserting 1110 the at least one magnet block 332 of the at least one magnet unit 330 into the at least one magnet cover device 333. In particular, the method 1000 subsequently comprises casting 1120 at least the at least one magnet cover device 333 with the at least one magnet block 332 inserted therein and the rotor laminated core 325 with a casting compound V, wherein the casting with the casting compound V takes place in particular counter to the force of gravity from bottom to top. Furthermore, the casting compound V is preferably cured 1130 and/or the auxiliary assembling tool 500 is removed 1140.

### LIST OF REFERENCE SIGNS

1 Generator
10 Generator segment
12 Air gap
100 Wind power installation
102 Tower
104 Nacelle
106 Rotor
106a Aerodynamic rotor
108 Rotor blades
109 Stator
110 Spinner
200 Stator segment
210 Coil carrier segment
211 Stator circumferential structure
220 Stator laminated core
220a First end portion of the stator laminated core
220b Second end portion of the stator laminated core
230 Stator lamination stack
231 Lamination stack units
232 First stator lamination element
233 Second stator lamination element
234 Spacer element
235 Recesses
250 Stator external circumferential face
251 Stator internal circumferential face
260 Coil unit
300 Rotor segment
310 Magnet carrier segment
320 Rotor internal circumferential face
325 Rotor laminated core
326 First clamping groove
327 Second clamping groove
330 Magnet unit
331 Rows of magnets
332 Magnet block
333 Magnet cover device
340 Circumferential gap
400 Fastening device
401 First clamping strip
402 Second clamping strip
411 First fastening groove
412 Second fastening groove
420 Fastening connector
421 Tensioning element
430 Damping element
500 Auxiliary assembling tool
501 Sliding device
502 Magnet feed ducts
600 Bearing unit
601 Stationary bearing part
602 Stator main body flange of a bearing unit
603 Rotating bearing part
604 Rotor main body flange of a bearing unit
605 Rolling elements
A Axial direction
D Axis of rotation
K Casting compound channel
P Laminated core spacing
R Radial direction
S Lamination stack spacing
U Circumferential direction
V Casting compound

1. A stator laminated core for receiving at least one coil unit of a stator segment of a stator of a generator for a wind turbine, comprising:
at least one stator lamination stack with two or more lamination stack units which are disposed so as to be spaced apart from one another in a circumferential direction and have a plurality of first stator lamination elements which are disposed next to one another in an axial direction;
wherein the at least one stator lamination stack comprises at least one second stator lamination element which differs from the first stator lamination element and connects adjacent lamination stack units of the two or more lamination stack units to one another.

2. The stator laminated core as claimed in claim 1, wherein:
the first stator lamination elements of the plurality of first stator lamination elements have a first lamination length in the circumferential direction, and the at least one second stator lamination element has a second lamination length in the circumferential direction, wherein the second lamination length extends at least twice as far in the circumferential direction in comparison with the first lamination length; and/or
the first stator lamination elements have a first lamination width in the axial direction, and the at least one second stator lamination element has a second lamination width in the axial direction which corresponds to the first lamination width.

3. The stator laminated core as claimed in claim 1, wherein
the two or more lamination stack units are disposed so as to be spaced apart from one another in the circumferential direction by a lamination stack spacing, the lamination stack spacing being more than 0 mm and/or at most 10 mm; and/or
the stator lamination stack extends in the circumferential direction with an arc angle of at least 10° and of at most 20°; and/or
the plurality of first stator lamination elements extend in the circumferential direction with an arc angle of at least 2.5° and of at most 7.5°; and/or
the at least one second stator lamination element extends in the circumferential direction with an arc angle of at least 7.5° and of at most 12.5°; and/or
the stator laminated core includes at least two stator lamination stacks, adjacent stator lamination stacks of the at least two stator lamination stacks being disposed so as to be spaced apart from one another in the axial direction.

4. A stator segment of a stator of a generator, for a wind turbine comprising:
a coil carrier segment having an annular or part-annular geometry and a stator circumferential structure; and
at least one stator laminated core as claimed in claim 1, which is configured to receive at least one coil unit and is disposed on the stator circumferential structure; and
a fastening device for fastening the at least one stator laminated core to the coil carrier segment,
wherein the fastening device is configured as a clamping device for the force-fitting and/or form-fitting connection of the at least one stator laminated core to the coil carrier segment.

5. The stator segment as claimed in claim 4, wherein:
stator laminated cores disposed adjacently in the circumferential direction are disposed on the stator circumferential structure so as to be spaced apart from one another by a laminated core spacing; wherein:
the laminated core spacing corresponds to the lamination stack spacing; or
the laminated core spacing is greater than the lamination stack spacing; or
the laminated core spacing is smaller than the lamination stack spacing; and/or
the fastening device comprises:
at least one first trapezoidal clamping strip, and/or at least one second partially trapezoidal clamping strip, for the force-fitting and/or form-fitting fastening of the fastening device to the at least one stator laminated core, wherein the first trapezoidal clamping strip is different than the second partially trapezoidal clamping strip;
wherein the at least one first and/or second clamping strip has at least one contact face for fastening the first and/or second clamping strip to the at least one stator laminated core, wherein the contact face has one or a plurality of punctiform and/or linear contact elevations, which are configured to produce a clamping connection with the stator laminated core by way of punctiform and/or linear contact;
a fastening connector for fastening the fastening device to the coil carrier segment and to the stator circumferential structure;
wherein the fastening connector comprises at least one tensioning element for the force-fitting and/or form-fitting connection of the at least one first and/or second clamping strip on the coil carrier segment and on the stator circumferential structure; and
at least one damping element for disposal between the at least one first and/or second clamping strip of the fastening device, and the stator laminated core; and/or
the at least one stator laminated core comprises:
at least one first trapezoidal fastening groove, and/or at least one second partially trapezoidal fastening groove, for receiving the fastening device and a first and/or second clamping strip of the at least one first and/or second clamping strip, wherein the first fastening groove is different from the second fastening groove;
wherein the at least one first and/or second fastening groove has at least one groove wall as a contact face for fastening the fastening device to the at least one first and/or second fastening groove, the groove wall having one or a plurality of punctiform and/or linear contact elevations which are configured to produce a clamping connection with the fastening device by way of punctiform and/or linear contact.

6. A stator of a generator of a wind turbine, comprising an annular stator segment as claimed in claim 4.

7. A rotor segment of a rotor of a generator for a wind turbine, comprising:
a magnet carrier segment having an annular or part-annular geometry and a rotor internal circumferential face,
at least one rotor laminated core, which is configured to receive at least one magnet unit and is disposed on the rotor internal circumferential face; and
at least one magnet unit, which is disposed on the rotor laminated core,
wherein the at least one magnet unit is connected in a materially integral manner to the rotor laminated core.

8. The rotor segment as claimed in claim 7, comprising at least one magnet cover device which is connected to the rotor laminated core, wherein one magnet unit is in each case disposed between a magnet cover device and the rotor laminated core, wherein the rotor laminated core has at least one first and/or second clamping groove for the force-fitting and/or form-fitting connection of the magnet cover device to the rotor laminated core, wherein the first clamping groove is different from the second clamping groove.

9. The rotor segment as claimed in claim 7, wherein the at least one magnet unit comprises at least one cuboid magnet block, wherein the magnet block at least on one side of the magnet block has grooves for distributing the casting compound between the magnet block and the rotor internal circumferential face;
wherein the at least one magnet block has an axial groove in an axial direction and/or a circumferential groove in a circumferential direction and/or a diagonal groove running diagonally to the axial direction and the circumferential direction; and/or
wherein the rotor segment includes a plurality of magnet units which on the rotor internal circumferential face are disposed spaced apart from one another in the circumferential direction, equidistantly; and/or
wherein, in the axial direction, two or more magnet units of the plurality of magnet units are disposed spaced apart from one another, wherein the magnet units disposed adjacently in the axial direction define a circumferential gap with a gap width; and/or
wherein the magnet units comprise one, two or more rows of magnets which are preferably disposed spaced apart from one another in the circumferential direction, equidistantly; and/or
wherein a row of magnets comprises one or a plurality of magnet blocks which are disposed next to one another in the axial direction.

10. The rotor segment as claimed in claim 7, wherein:
the rotor laminated core is connected in a materially integral manner, in particular with a welded connection, to the magnet carrier segment; and/or
the rotor laminated core has at least one casting compound channel on a rotor laminated core internal circumferential face, wherein the at least one casting compound channel is configured as a groove, wherein the at least one casting compound channel has an axial channel in an axial direction and/or a circumferential channel in a circumferential direction and/or a diagonal channel that runs diagonally to the axial direction.

11. A rotor of a generator of a wind turbine, comprising an annularly configured rotor segment as claimed in claim 7.

12. A generator for a wind turbine, comprising a stator as claimed in claim 6 and a rotor including an annularly configured rotor segment including:
a magnet carrier segment having an annular or part-annular geometry and a rotor internal circumferential face,
at least one rotor laminated core, which is configured to receive at least one magnet unit and is disposed on the rotor internal circumferential face; and
at least one magnet unit, which is disposed on the rotor laminated core,
wherein the at least one magnet unit is connected in a materially integral manner to the rotor laminated core.

13. A wind turbine comprising a generator as claimed in claim 12.

14. A method for producing a rotor segment of a rotor of a generator for a wind turbine, the method comprising:
providing a magnet carrier segment having an annular or part-annular geometry and a rotor internal circumferential face, and
providing at least one rotor laminated core, which is configured to receive at least one magnet unit and is disposed on the rotor internal circumferential face; and
providing at least one magnet unit with at least one magnet block; and
disposing the at least one magnet unit on the rotor laminated core; and
connecting in a materially integral manner the at least one magnet unit to the rotor laminated core.

15. The method as claimed in claim 14, wherein
connecting in a materially integral manner the at least one magnet unit to the rotor laminated core comprises:
casting the at least one magnet unit on the rotor laminated core so that a casting compound at least partially encloses the magnet unit; and/or
the method further comprises:
providing at least one magnet cover device; and/or
providing an auxiliary assembling tool, wherein the auxiliary assembling tool is composed of steel or comprises the latter, and wherein the auxiliary assembling tool is a negative mold of the at least one magnet cover device and/or of the rotor laminated core internal circumferential face; and/or
fastening the at least one rotor laminated core to the rotor internal circumferential face of the magnet carrier segment; and/or
fastening the at least one magnet cover device to the rotor laminated core; and/or
disposing the auxiliary assembling tool on the magnet carrier segment so that the auxiliary assembling tool encloses the at least one magnet cover device and/or the at least one rotor laminated core; and/or
inserting the at least one magnet block of the at least one magnet unit into the at least one magnet cover device; and/or
casting at least the at least one magnet cover device including the at least one magnet block inserted therein and the rotor laminated core with a casting compound, wherein the casting with the casting compound is performed counter to gravity from bottom to top; and/or
curing the casting compound; and/or
removing the auxiliary assembling tool.

16. The method of claim 14, further comprising:
using an auxiliary assembling tool to produce the rotor segment; and
using the auxiliary tool to dispose the at least one magnet unit on the rotor laminated core and to connect in a materially integral manner the at least one magnet unit to the rotor laminated core.

17. The stator laminated core as claimed in claim 1, wherein:
the stator is a segmented stator of a segmented generator;
the plurality of first stator lamination elements are stacked in the axial direction; and
the at least one stator lamination stack comprises two second stator lamination elements.

18. The stator laminated core as claimed in claim 3, wherein:
the lamination stack spacing is at least 0.5 mm and/or at most 7.5 mm; and/or
the stator lamination stack extends in the circumferential direction with an arc angle of 15°±1°; and/or
the plurality of first stator lamination elements extend in the circumferential direction with an arc angle of 5°±1°; and/or
the at least one second stator lamination element extends in the circumferential direction with an arc angle of 10°±1°.

19. The stator laminated core as claimed in claim 18, wherein:
the lamination stack spacing is at least 1 mm and/or at most 5 mm.

20. The stator laminated core as claimed in claim 18, wherein:
the lamination stack spacing is at least 1.5 mm and/or at most 3 mm.
